(19) United States
(12) Patent Application Publication
(10) Pub. No.: US 2025/0062070 A1
(43) Pub. Date: Feb. 20, 2025

(54) MULTILAYER CERAMIC CAPACITOR AND METHOD FOR MANUFACTURING MULTILAYER CERAMIC CAPACITOR

(71) Applicant: Murata Manufacturing Co., Ltd., Nagaokakyo-shi (JP)

(72) Inventors: Kazunori USUI, Nagaokakyo-shi (JP); Tatsunori YASUDA, Nagaokakyo-shi (JP)

(21) Appl. No.: 18/937,286

(22) Filed: Nov. 5, 2024

Related U.S. Application Data
(63) Continuation of application No. PCT/JP2023/016531, filed on Apr. 26, 2023.

(30) Foreign Application Priority Data
Jul. 22, 2022 (JP) 2022-117487

(51) Int. Cl. H01G 4/008; H01G 4/232; H01G 4/30

(52) U.S. Cl. CPC H01G 4/0085; H01G 4/232; H01G 4/30

(57) ABSTRACT

A multilayer ceramic capacitor include a multilayer body including internal electrode layers including first and second internal electrode layers facing each other and separated from each other, and a dielectric layer between the first and second internal electrode layers and including a ceramic material, and an outer electrode selectively connected to the first and second internal electrode layers. Each of the first and second internal electrode layers includes a rare earth oxide distributed along at least one of a pair of interfaces with the dielectric layer.

### CROSS REFERENCE TO RELATED APPLICATIONS

This application claims the benefit of priority to Japanese Patent Application No. 2022-117487 filed on Jul. 22, 2022 and is a Continuation application of PCT Application No. PCT/JP2023/016531 filed on Apr. 26, 2023. The entire contents of each application are hereby incorporated herein by reference.

### BACKGROUND OF THE INVENTION

### 1. Field of the Invention

The present invention relates to multilayer ceramic capacitors and methods for manufacturing multilayer ceramic capacitors.

### 2. Description of the Related Art

With the recent development of electronics technology, a multilayer ceramic capacitor is required to be reduced in size and increased in capacitance. In order to satisfy the demand for a large capacitance, barium titanate (BaTiO₃), which has a high dielectric constant and can achieve the large capacitance, is generally used as a main component of a dielectric material of a multilayer ceramic capacitor.

However, the above-described conventional technique has the following disadvantages. That is, BaTio₃ as a dielectric material generates an oxygen vacancy in firing under a reduction atmosphere due to its characteristics. The oxygen vacancies cause a decrease in the insulation resistance of the dielectric, and may decrease the reliability of the multilayer ceramic capacitor against a high temperature load.

### SUMMARY OF THE INVENTION

Example embodiments of the present invention provide multilayer ceramic capacitors each with a high dielectric constant and a high capacitance by reducing or preventing a decrease in reliability due to oxygen vacancies, and method for manufacturing such multilayer ceramic capacitors.

A multilayer ceramic capacitor according to an example embodiment of the present invention includes a multilayer body including a plurality of stacked dielectric layers and a plurality of stacked internal electrode layers, a first main surface and a second main surface opposed to each other in a height direction, a first side surface and a second side surface opposed to each other in a width direction orthogonal or substantially orthogonal to the height direction, and a first end surface and a second end surface opposed to each other in a length direction orthogonal or substantially orthogonal to the height direction and the width direction, and a plurality of outer electrodes. The plurality of internal electrode layers include first internal electrode layers alternately stacked with the plurality of dielectric layers and exposed at the first end surface, and second internal electrode layers alternately stacked with the plurality of dielectric layers and exposed at the second end surface. The plurality of outer electrodes include a first outer electrode connected to the first internal electrode layers, and a second outer electrode connected to the second internal electrode layers. The first internal electrode layers and the second internal electrode layers include a rare earth oxide. The rare earth oxide in each electrode layer of the first internal electrode layers and the second internal electrode layers is distributed along at least one of a pair of interfaces with the dielectric layer.

In the above-described multilayer ceramic capacitor, the first internal electrode layers and the second internal electrode layers include a rare earth oxide, and the rare earth oxide in each of the first internal electrode layers and the second internal electrode layers is distributed along at least one of the pair of interfaces with the dielectric layers, and oxygen vacancies extending from the dielectric layers to the internal electrode layers are absorbed by the rare earth oxide included in the interface on an internal electrode layers side. Thus, in the dielectric layers in the vicinity of the interface on a dielectric layer side, accumulation of oxygen vacancies and electric field concentration due to the accumulation are reduced or prevented, and a decrease in insulation resistance can be reduced or prevented. As a result, the reliability of the dielectric layer is prevented from being lowered.

According to example embodiments of the present invention, it is possible to provide multilayer ceramic capacitors with a high dielectric constant and a high capacitance by reducing or preventing a decrease in reliability due to oxygen vacancies, and methods for manufacturing such multilayer ceramic capacitors.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a two-terminal multilayer ceramic capacitor according to a first example embodiment of the present invention.

FIG. 2 is a front view illustrating an example of the two-terminal multilayer ceramic capacitor according to the first example embodiment of the present invention.

FIG. 3 is a cross-sectional view taken along line III-III in FIG. 1.

FIG. 4 is a cross-sectional view taken along line IV-IV in FIG. 1.

FIG. 5 is a cross-sectional view taken along line V-V in FIG. 3.

FIG. 6 is a view illustrating the configuration of the vicinity of internal electrode layers of the two-terminal multilayer ceramic capacitor according to the first example embodiment of the present invention, in a region R1 of FIG. 3.

FIG. 7 is a plan view corresponding to FIG. 3, illustrating the configuration of the internal electrode layers of the two-terminal multilayer ceramic capacitor according to the first example embodiment of the present invention.

FIG. 8 is a view illustrating the configuration of the vicinity of the internal electrode layers of the two-terminal multilayer ceramic capacitor according to the first example embodiment of the present invention, in a region R2 of FIG. 7.

FIG. 9 is a view illustrating the configuration of the vicinity of the internal electrode layers in the region R1 of FIG. 2 in another example of the two-terminal multilayer ceramic capacitor according to the first example embodiment of the present invention.

FIG. 10 is a view illustrating the configuration of the vicinity of the internal electrode layers in the region R2 of FIG. 7 in another example of the two-terminal multilayer ceramic capacitor according to the first example embodiment of the present invention.

FIG. 11 is an external perspective view illustrating an example of a three-terminal multilayer ceramic capacitor according to a second example embodiment of the present invention.

FIG. 12 is a top view illustrating an example of the three-terminal multilayer ceramic capacitor according to the second example embodiment of the present invention.

FIG. 13 is a front view illustrating an example of the three-terminal multilayer ceramic capacitor according to the second example embodiment of the present invention.

FIG. 14 is a cross-sectional view taken along line XIV-XIV in FIG. 11.

FIG. 15 is a cross-sectional view taken along line XV-XV in FIG. 11.

FIG. 16 is a cross-sectional view taken along line XVI-XVI in FIG. 14.

FIG. 17 is a cross-sectional view taken along line XVII-XVI in FIG. 14.

### DETAILED DESCRIPTION OF THE EXAMPLE EMBODIMENTS

Example embodiments of the present invention will be described in detail below with reference to the drawings.

### A. First Example Embodiment

### 1. Two-terminal Multilayer Ceramic Capacitor

A two-terminal multilayer ceramic capacitor 10 will be described as a multilayer ceramic capacitor according to a first example embodiment of the present invention.

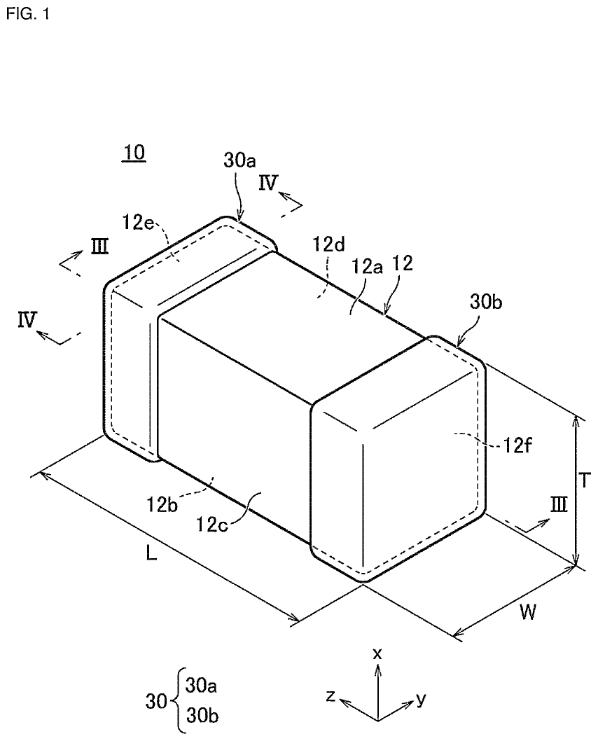

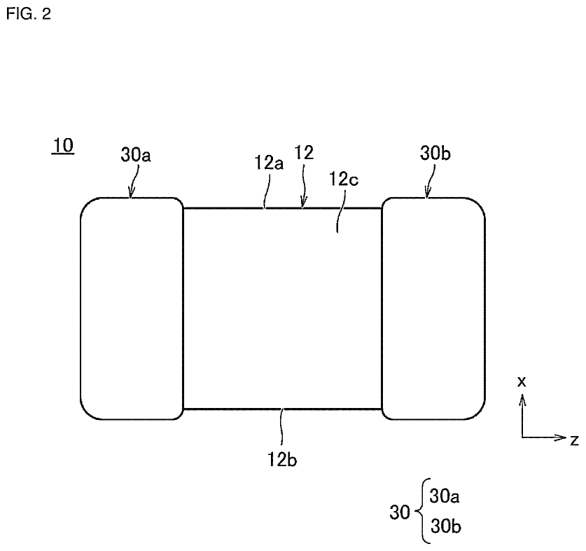

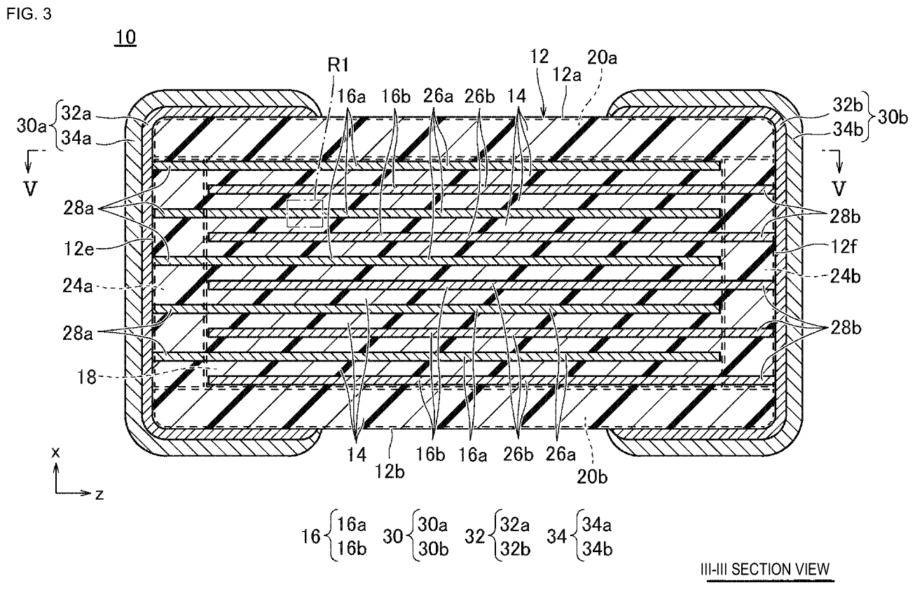

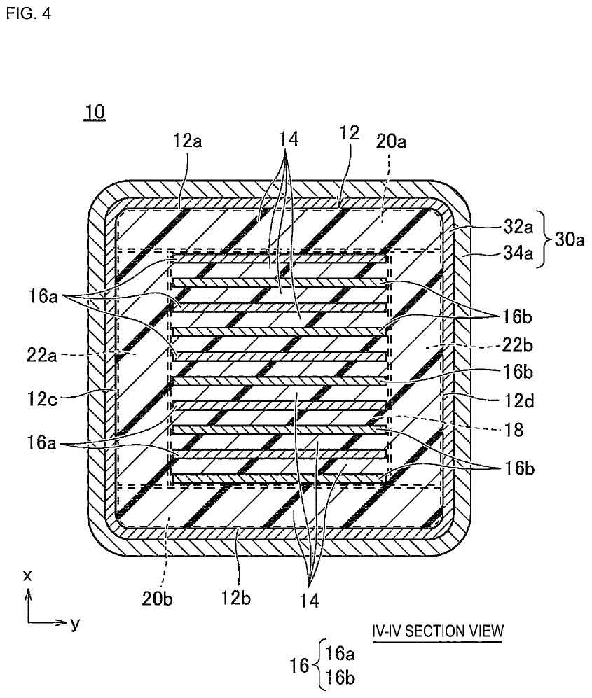

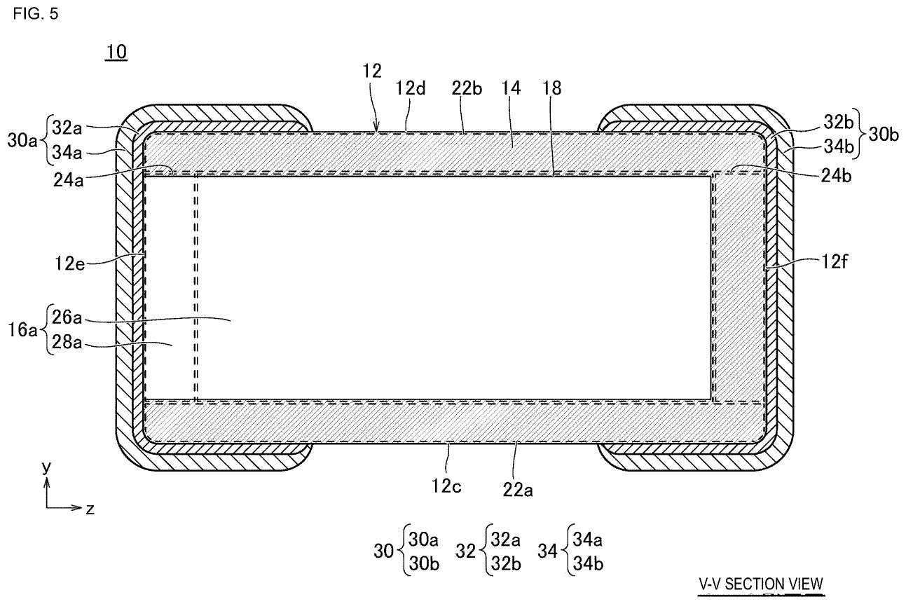

FIG. 1 is an external perspective view illustrating an example of a two-terminal multilayer ceramic capacitor according to the first example embodiment of the present invention. FIG. 2 is a front view illustrating an example of the two-terminal multilayer ceramic capacitor according to the first example embodiment of the present invention. FIG. 3 is a cross-sectional view taken along line III-III in FIG. 1. FIG. 4 is a cross-sectional view taken along line IV-IV in FIG. 1. FIG. 5 is a cross-sectional view taken along line V-V in FIG. 3.

As illustrated in FIG. 1 to FIG. 4, the multilayer ceramic capacitor 10 includes a multilayer body 12 and an outer electrode 30 disposed on the surfaces of the multilayer body 12.

As illustrated in FIG. 1 to FIG. 4, the multilayer ceramic capacitor 10 includes the rectangular or substantially rectangular parallelepiped multilayer body 12 and the outer electrode 30 disposed at both end portions of the multilayer body 12.

The multilayer body 12 includes a plurality of stacked dielectric layers 14 and a plurality of internal electrode layers 16 stacked on the dielectric layers 14. The multilayer body 12 further includes a first main surface 12a and a second main surface 12b opposed to each other in a height direction x, a first side surface 12c and a second side surface 12d opposed to each other in a width direction y orthogonal or substantially orthogonal to the height direction x, and a first end surface 12e and a second end surface 12f opposed to each other in a length direction z orthogonal or substantially orthogonal to the height direction x and the width direction y. The multilayer body 12 includes a rounded corner portion and a ridge portion. The corner portion is a portion where three adjacent surfaces of the multilayer body intersect each other, and the ridge portion is a portion where two adjacent surfaces of the multilayer body intersect each other. In addition, irregularities or the like may be provided in a portion or all of the first main surface 12a and the second main surface 12b, the first side surface 12c and the second side surface 12d, and the first end surface 12e and the second end surface 12f. The dielectric layers 14 and the internal electrode layers 16 are stacked in the height direction x.

The multilayer body 12 includes an inner layer portion 18 including one or the plurality of dielectric layers 14 and the plurality of internal electrode layers 16 disposed thereon. The internal electrode layers 16 include first internal electrode layers 16a extending to the first end surface 12e and second internal electrode layers 16b extending to the second end surface 12f, and in the inner layer portion 18, the plurality of first internal electrode layers 16a and the plurality of second internal electrode layers 16b face each other with the dielectric layers 14 interposed therebetween.

The multilayer body 12 includes a first main-surface-side outer layer portion 20a that is located on the first main surface 12a side and includes the plurality of dielectric layers 14 located between the first main surface 12a and the outermost surface of the inner layer portion 18 on the first main surface 12a side and on a straight line extending from the outermost surface.

Similarly, the multilayer body 12 includes a second main-surface-side outer layer portion 20b that is located on the second main surface 12b side and includes the plurality of dielectric layers 14 located between the second main surface 12b and the outermost surface of the inner layer portion 18 on the second main surface 12b side and on a straight line extending from the outermost surface.

The multilayer body 12 includes a first side-surface-side outer layer portion 22a that is located on the first side surface 12c side and is formed of the plurality of dielectric layers 14 located between the first side surface 12c and the outermost surface of the inner layer portion 18 on the first side surface 12c side.

Similarly, the multilayer body 12 includes a second side-surface-side outer layer portion 22b that is located on the second side surface 12d side and includes the plurality of dielectric layers 14 located between the second side surface 12d and the outermost surface of the inner layer portion 18 on the second side surface 12d side.

The multilayer body 12 includes a first end-surface-side outer layer portion 24a that is located on the first end surface 12e side and includes the plurality of dielectric layers 14 located between the first end surface 12e and the outermost surface of the inner layer portion 18 on the first end surface 12e side.

Similarly, the multilayer body 12 includes a second end-surface-side outer layer portion 24b that is located on the second end surface 12f side and includes the plurality of dielectric layers 14 located between the second end surface 12f and the outermost surface of the inner layer portion 18 on the second end surface 12f side.

The first main-surface-side outer layer portion 20a is located on the first main surface 12a side of the multilayer body 12 and is an aggregate of the plurality of dielectric layers 14 located between the first main surface 12a and the internal electrode layer 16 closest to the first main surface 12a.

The second main-surface-side outer layer portion 20b is located on the second main surface 12b side of the multilayer body 12 and is an aggregate of the plurality of dielectric layers 14 located between the second main surface 12b and the internal electrode layer 16 closest to the second main surface 12b.

The dielectric layer 14 can be made of a dielectric material, for example, as a ceramic material. As such a dielectric material, for example, a dielectric ceramic including components such as BaTiO₃, CaTiO₃, SrTiO₃, or CaZrO₃ can be used. When the above dielectric material is included as a main component, a dielectric material to which a subcomponent having a content smaller than that of the main component, for example, such as a Mn compound, a Fe compound, a Cr compound, a Co compound, or a Ni compound, is added may be used according to the desired characteristics of the multilayer body 12.

The dimensions of the multilayer body 12 are not particularly limited.

The dielectric layer 14 is made of, for example, a dielectric material including barium titanate (BaTiO₃) as a main component. In this case, the main component is not particularly limited as long as it is a perovskite oxide including barium (Ba) and titanium (Ti). That is, for example, this compound may be BaTiO₃, or may be BaTiO₃ in which a portion of Ba and/or Ti included therein is substituted with other elements.

Specifically, for example, a portion of Ba may be substituted with Sr and/or Ca, or need not be substituted. In addition, a portion of Ti may be substituted with Zr and/or Hf, or need not be substituted. Further, the ratio of the A-site element (Ba, Sr, Ca, etc.) to the B-site element (Ti, Zr, Hf, etc.) in the BaTiO₃ compound is not strictly limited to 1:1. As long as the perovskite crystal structure is maintained, a deviation in the ratio of the A-site element to the B-site element is allowed.

When the above dielectric material is included as a main component, a dielectric material to which a subcomponent having a content smaller than that of the main component, for example, such as a Mn compound, a Fe compound, a Cr compound, a Co compound, or a Ni compound, is added may be used according to the desired characteristics of the multilayer body 12.

The thinner the dielectric layer 14 is, the larger the capacitance of the capacitor is, and therefore the crystal grain size is, for example, preferably about 1 μm or less. As the thickness of the dielectric layer 14 decreases, the crystal grains become smaller, but if the crystal grains become too small, the relative dielectric constant decreases due to the size effect. Therefore, the size of the crystal grains is appropriately designed according to the thickness of the dielectric layer 14.

The thickness of the dielectric layer 14 in the fired multilayer body 12 is, for example, preferably about 0.4 μm or more and about 1.0 μm or less.

The number of the dielectric layers 14 to be stacked is, for example, preferably 4 or more and 1000 or less. However, the number of the dielectric layers 14 is the total of the number of the dielectric layers 14 in the inner layer portion 18 and the number of the dielectric layers of the first main-surface-side outer layer portion 20a and the second main-surface-side outer layer portion 20b.

The multilayer body 12 includes the plurality of first internal electrode layers 16a and the plurality of second internal electrode layers 16b as the plurality of internal electrode layers 16. The plurality of first internal electrode layers 16a and the plurality of second internal electrode layers 16b are embedded so as to be parallel or substantially parallel to the first main surface 12a and the second main surface 12b and alternately arranged at equal or substantially equal intervals with the dielectric layer 14 interposed therebetween along the height direction x of the multilayer body 12.

The first internal electrode layers 16a are disposed on the plurality of dielectric layers 14 and located inside the multilayer body 12. The first internal electrode layers 16a include first opposing electrode portions 26a opposed to the second internal electrode layers 16b and first extended electrode portions 28a located on one end side of the first internal electrode layers 16a and extending from the first opposing electrode portions 26a to the first end surface 12e of the multilayer body 12. The first extended electrode portion 28a has an end portion extended to the surface of the first end surface 12e and exposed from the multilayer body 12.

The shape of the first opposing electrode portion 26a of the first internal electrode layer 16a is not particularly limited, but is, for example, preferably a rectangular or substantially rectangular shape in plan view. However, the corner portion may be rounded in plan view, or the corner portion may be oblique in plan view (e.g., a tapered shape). Further, the shape may be a tapered shape in plan view in which the shape is inclined toward either side.

The shape of the first extended electrode portion 28a of the first internal electrode layer 16a is not particularly limited, but is, for example, preferably a rectangular or substantially rectangular shape in plan view. However, the corner portion may be rounded in plan view, or the corner portion may be oblique in plan view (e.g., a tapered shape). Further, the shape may be a tapered shape in plan view in which the shape is inclined toward either side.

The width of the first opposing electrode portion 26a of the first internal electrode layer 16a and the width of the first extended electrode portion 28a of the first internal electrode layer 16a may be equal or substantially equal to each other, or one of the widths may be smaller than the other.

The second internal electrode layers 16b are disposed on the plurality of dielectric layers 14 and located inside the multilayer body 12. The second internal electrode layers 16b include second opposing electrode portions 26b opposed to the first internal electrode layers 16a, and second extended electrode portions 28b located on one end side of the second internal electrode layers 16b and extending from the second opposing electrode portions 26b to the second end surface 12f of the multilayer body 12. The second extended electrode portion 28b includes an end portion extended to the surface of the second end surface 12f and exposed from the multilayer body 12.

The shape of the second opposing electrode portion 26b of the second internal electrode layer 16b is not particularly limited, but is, for example, preferably a rectangular or substantially rectangular shape in plan view. However, the corner portion may be rounded in plan view, or the corner portion may be oblique in plan view (e.g., a tapered shape). Further, the shape may be a tapered shape in plan view in which the shape is inclined toward either side.

The shape of the second extended electrode portion 28b of the second internal electrode layer 16b is not particularly limited, but is, for example, preferably a rectangular shape in plan view. However, the corner portion may be rounded in plan view, or the corner portion may be oblique in plan view (e.g., a tapered shape). Further, the shape may be a tapered shape in plan view in which the shape is inclined toward either side.

The width of the second opposing electrode portion 26b of the second internal electrode layer 16b and the width of the second extended electrode portion 28b of the second internal electrode layer 16b may be equal or substantially equal to each other, or one of the widths may be smaller than the other.

The first internal electrode layer 16a and the second internal electrode layer 16b may be made of an appropriate conductive material, for example, metals such as Ni, Cu, Ag, Pd, and Au, or alloys including at least one of these metals, such as an Ag—Pd alloy.

The thickness of each of the first internal electrode layers 16a and the second internal electrode layers 16b is not particularly limited, but is, for example, preferably about 0.4 μm or more and about 0.8 μm or less, for example.

The number of the first internal electrode layers 16a and the number of the second internal electrode layers 16b are not particularly limited, but are, for example, preferably 2 or more and 1000 or less in total.

Next, the internal electrode layer 16 includes, for example, a mixture of an appropriate conductive material of a metal such as Ni, Cu, Ag, Pd, or Au, or an alloy including at least one of these metals such as an Ag—Pd alloy, and a rare earth oxide obtained by adding at least one of calcium oxide, magnesium oxide, and yttrium oxide to zirconia.

When the underlying electrode layer of the outer electrode 30 described below includes a conductive resin layer, the metal of the internal electrode layer 16 forms a compound with the metal of the conductive filler included in the conductive resin layer.

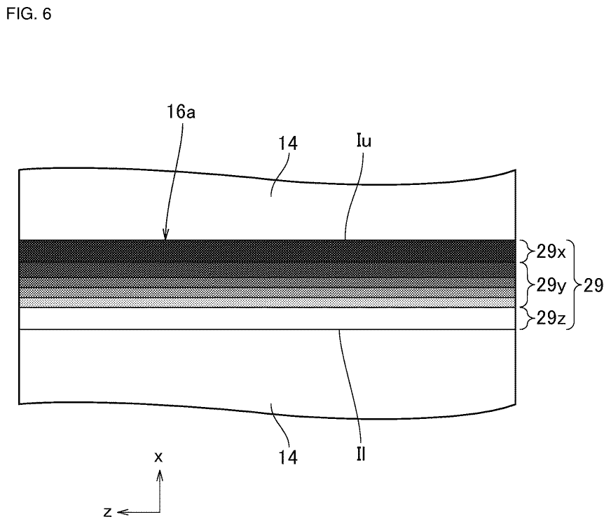

Further, as illustrated in FIG. 6, which is an enlarged view of a main portion of the region R1 in FIG. 3, an interface layer 29x including the largest amount of rare earth oxides is disposed in a portion including the surface defining an interface Iu with the dielectric layer 14 stacked in an upper portion of the first internal electrode layer 16a. On the other hand, an electrode body layer 29z including the conductive material without rare earth oxides is disposed on the back side portion defining an interface Il with the dielectric layer 14 stacked in a lower portion of the first internal electrode layer 16a. Furthermore, an intermediate layer 29y, which is a layer in which the content of rare earth oxides decreases as the distance from the interface layer 29x increases and the distance to the electrode body layer 29z decreases along the height direction x, is disposed between the interface layer 29x and the electrode body layer 29z.

In FIG. 6, the intermediate layer 29y is shown by a stepwise change in color shade, but the distribution of the rare earth oxides in the intermediate layer 29y has a continuous change.

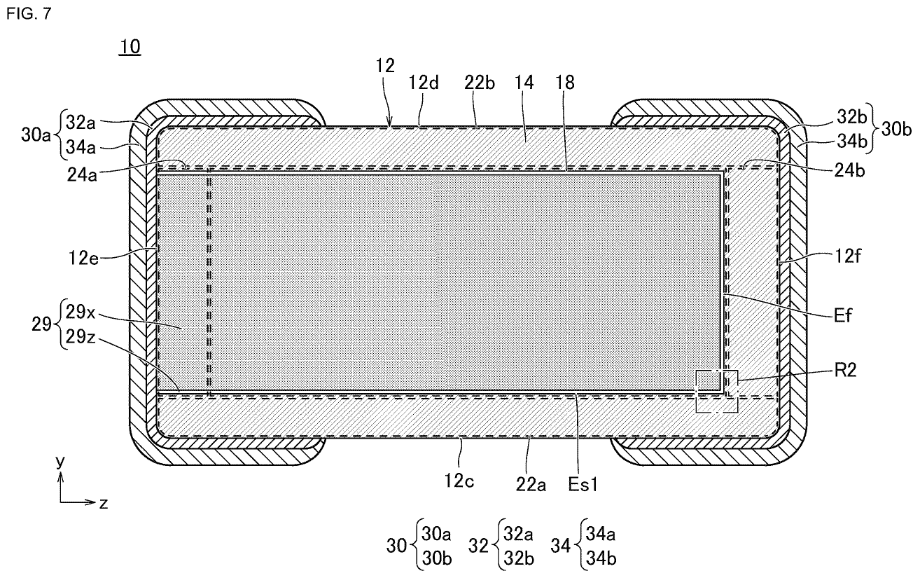

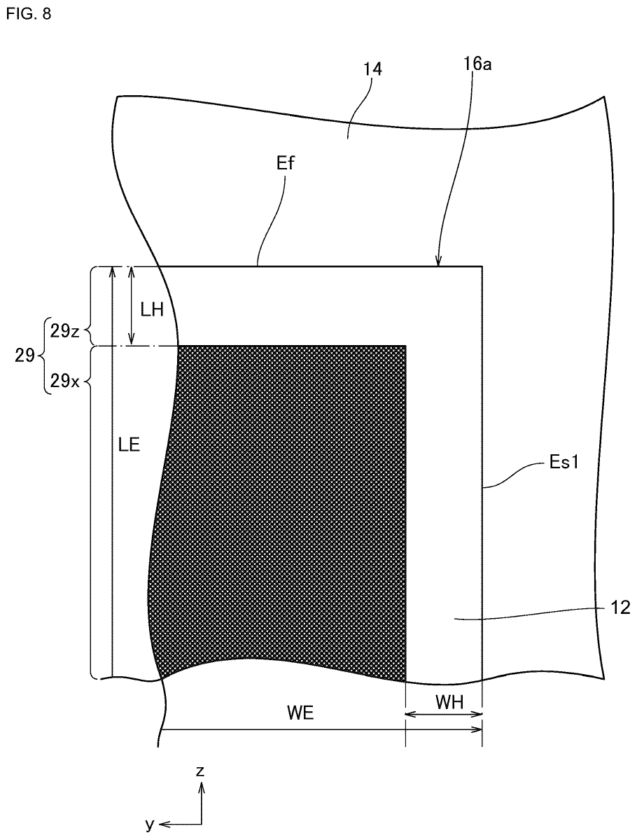

Further, as illustrated in FIG. 7 and FIG. 8, the first internal electrode layer 16a may have a configuration in which the outline of the electrode body layer 29z protrudes from the outline of the interface layer 29x when viewed in the height direction x. Specifically, the interface layer 29x may recede from the electrode body layer 29z toward the first end surface 12e side at a front edge Ef of the first opposing electrode portion 26a, the front edge Ef being opposed to the second end surface 12f of the multilayer body 12. In addition, the interface layer 29x may recede from the electrode body layer 29z toward the second side surface 12d side at a first side edge Es1 of the first opposing electrode portion 26a and the first extended electrode portion 28a, the first side edge Es1 being opposed to the first side surface 12c of the multilayer body 12. In addition, the interface layer 29x may recede from the electrode body layer 29z toward the first side surface 12c side at a second side edge Es2 of the first opposing electrode portion 26a and the first extended electrode portion 28a, the second side edge Es2 being opposed to the second side surface 12d of the multilayer body 12.

Thus, in the first internal electrode layer 16a, on an LW plane in the multilayer body 12, the outline portion surrounded by the front edge Ef, the first side edge Es1, and the second side edge Es2 is defined only by the electrode body layer 29z, and the remaining portion located closer to the center than the outline portion is constituted by the stacking of the interface layer 29x and the electrode body layer 29z.

As illustrated in FIG. 3 and FIG. 4, in the multilayer body 12, the first internal electrode layers 16a and the second internal electrode layers 16b are provided in line symmetry with respect to the inner layer portion 18 in the height direction x. Therefore, the various aspects of the configuration and the shape as viewed in the height direction x of the first internal electrode layers 16a described above are similarly applied to the second internal electrode layers 16b reversed in the length direction z. Specifically, the second internal electrode layers 16b have a rectangular or substantially rectangular shape when viewed in the height direction x, and include the second opposing electrode portions 26b opposed to the first internal electrode layers 16a, and the second extended electrode portions 28b located on one end side of the second internal electrode layers 16b in the length direction z and extended from the second opposing electrode portions 26b to the surface of the second end surface 12f of the multilayer body 12 to be exposed from the multilayer body 12. The second opposing electrode portion 26b of the second internal electrode layer 16b corresponds to the first opposing electrode portion 26a of the first internal electrode layer 16a, and the second extended electrode portion 28b of the second internal electrode layer 16b corresponds to the first extended electrode portion 28a of the first internal electrode layer 16a.

The first internal electrode layers 16a and the second internal electrode layers 16b may be alternately stacked with the dielectric layers 14 interposed therebetween, or the plurality of dielectric layers 14 on which the first internal electrode layers 16a are disposed may be stacked, and then the dielectric layers 14 on which the second internal electrode layers 16b are disposed may be stacked. In this way, the stacking pattern of the first internal electrode layers 16a and the second internal electrode layers 16b can be changed according to the capacitance value desired to be achieved in the two-terminal multilayer ceramic capacitor 10.

In the multilayer ceramic capacitor 10 having the above-described configuration, the first internal electrode layers 16a and the second internal electrode layers 16b of the internal electrode layers 16 include rare earth oxides distributed along the interface Iu with the dielectric layer 14. In the following description, the first internal electrode layers 16a are taken as an example based on the drawings to be referred to, but the same applies to the second internal electrode layers 16b.

Furthermore, in the multilayer ceramic capacitor 10 of the present example embodiment, as shown in the intermediate layer 29y of the first internal electrode layer 16a of the internal electrode layer 16 in FIG. 6, the rare earth oxides are distributed along the thickness direction of each electrode layer of the internal electrode layers 16 so that the content thereof decreases as the distance from the interface layer 29x increases and the distance to the electrode body layer 29z decreases. As a result, each electrode layer of the internal electrode layers 16 can absorb oxygen vacancies not only at the interface Iu between the dielectric layer 14 and the internal electrode layer 16 but also in the inside thereof, and as a result, it is possible to reduce or prevent a decrease in insulation resistance of the dielectric layer 14 and reduce or prevent a decrease in reliability while ensuring the inherent conductivity of the internal electrode layer 16.

Next, the content rate of the rare earth oxide in the internal electrode layer 16 is, for example, preferably about 0.1 wt % or more and about 10 wt % or less, based on {(weight of rare earth oxide)/(weight of rare earth oxide+weight of main component metal of each of the plurality of internal electrode layers)}×100.

This makes it possible to reduce or prevent a decrease in the insulation resistance of the dielectric layer 14 while reducing the possibility of the conductive performance of the internal electrode layer 16 being impaired.

That is, when the content rate of the rare earth oxide in the internal electrode layer 16 is less than about 0.1 wt %, there is a possibility that the oxygen vacancies moved from the dielectric layer 14 of the multilayer body 12 cannot be sufficiently absorbed. On the other hand, if the content rate of the rare earth oxide in the internal electrode layer 16 is more than about 10 wt %, the ratio of the main component metal to other conductive components in the internal electrode layer 16 decreases, the electrical resistance increases, and the inherent conductive performance of the electrode layer may be impaired.

The content rate of the rare earth oxides in the first internal electrode layers 16a of the internal electrode layers 16 is measured, for example, as follows. First, the multilayer body 12 is polished to a position where a W dimension is about ½ along the width direction y so that an LT cross section is exposed, and the LT cross section exposed by polishing is analyzed by energy dispersive X-ray analysis or wavelength dispersive X-ray analysis (EDS, WDX/FE-WDX (e.g., using a scanning electron microscope or an electron probe microanalyzer manufactured by JEOL Ltd.)), and the value is obtained as a calculated value calculated based on the analysis result. Here, the content rate of the rare earth oxide is higher on the interface side when the internal electrode layer 16 is divided into five equal portions.

Further, as illustrated in FIG. 7 and FIG. 8, which is an enlarged view of a main portion of the region R2 in FIG. 7, in the multilayer ceramic capacitor 10 of the present example embodiment, the first internal electrode layers 16a have a configuration in which the outline portion is defined by only the electrode body layer 29z and the remaining portion located closer to the center than the outline portion is defined by the interface layer 29x and the electrode body layer 29z on the LW plane in the multilayer body 12 as the configuration viewed in the height direction x of the first internal electrode layers 16a of the internal electrode layers 16.

This makes it possible to reduce or prevent a decrease in insulation performance due to oxygen vacancies while reducing or preventing an increase in electrical resistance of the internal electrode layers 16, and to reduce or prevent a decrease in reliability of the dielectric layers 14. That is, in the internal electrode layer 16, Ni or the like, which is a conductive material as a main component of the electrode layer, has a lower electrical resistance than the rare earth oxide, and the current flows more easily on the side along the outline portion than on the side closer to the center of the LW plane of the internal electrode layer 16. In the multilayer ceramic capacitor 10 of the present example embodiment, by utilizing these facts, the outline portion of the internal electrode layer 16 where the current easily flows is exposed, while the interface layer 29x is provided in the portion closer to the center where the current relatively hardly flows, such that the influence of the increase in electrical resistance due to the addition of the interface layer 29x in the internal electrode layer 16 is reduced or prevented.

In particular, in the first internal electrode layer 16a, the dimension of the outline portion where the electrode body layer 29z is exposed alone on the LW plane in the multilayer body 12 is, for example preferably such that a dimension LH in the length direction z, which is the extending direction of the first internal electrode layer 16a, is about 2% or less of an overall dimension LE of the first internal electrode layer 16a in the length direction z, for example. Similarly, a dimension WH of the outline portion where the electrode body layer 29z is exposed alone in the width direction y, which is a direction orthogonal to the extending direction of the first internal electrode layer 16a, is, for example, preferably about 2% or less of an overall dimension WE of the first internal electrode layer 16a in the width direction y, for example.

This makes it possible to keep a balance between the reduction or prevention of the increase in the electrical resistance of the internal electrode layer 16 and the reduction or prevention of the decrease in the insulation performance due to the oxygen vacancies, and to reduce or prevent the decrease in the reliability of the dielectric layer 14. That is, when the dimension of the outline portion where the electrode body layer 29z including no rare earth oxides is exposed alone is, for example, larger than about 2% of the overall dimension of the first internal electrode layer 16a, the ratio of the rare earth oxides in the internal electrode layer 16 to other elements decreases, and thus the oxygen vacancies of the dielectric layer 14 cannot be sufficiently absorbed and the decrease in the reliability of the insulation performance cannot be sufficiently reduced or prevented.

In the above description, the entire or substantially the entire outline portion of the first internal electrode layer 16a surrounded by the front edge Ef, the first side edge Es1, and the second side edge Es2 on the LW plane in the multilayer body 12 is defined by the electrode body layer 29z alone, but only one of the first and second side edges Es1 and Es2 and the front edge Ef may be defined by the electrode body layer 29z alone. In particular, the larger one of the dimension of the first side edge Es1 and the second side edge Es2 in the length direction z and the dimension of the front edge Ef in the width direction y is preferably defined by only the electrode body layer 29z. This makes it possible to reduce or prevent the decrease in the insulation performance due to the oxygen vacancies while reducing or preventing the increase in the electrical resistance of the internal electrode layer 16, and to more efficiently reduce or prevent the decrease in the reliability of the dielectric layer 14.

The interface layer 29x in the first internal electrode layer 16a of the internal electrode layer 16 is measured, for example, as follows. First, the multilayer body 12 is polished to a position where a T dimension is about ½ along the height direction x so that the LW cross section is exposed, and the LW cross section exposed by polishing is imaged by a microscope (for example, VHX series manufactured by Keyence Corporation). The dimensions in the length direction z and width direction y, i.e., L and W dimensions, of the interface layer 29x and the first internal electrode layer 16a are determined based on the captured images. Further, based on the dimensions, it is calculated whether the dimension of the outline portion where the electrode body layer 29z is exposed alone is, for example, less than about 2% of the overall dimension of the first internal electrode layer 16a in each of the length direction z and the width direction y.

Here, the expression “including no rare earth oxide” means that the rare earth oxide is not included when the content rate of the rare earth oxide is, for example, less than about 0.1 wt %, based on [(weight of rare earth oxide)/weight of rare earth oxide+weight of main component metal of each of the plurality of internal electrode layers]×100.

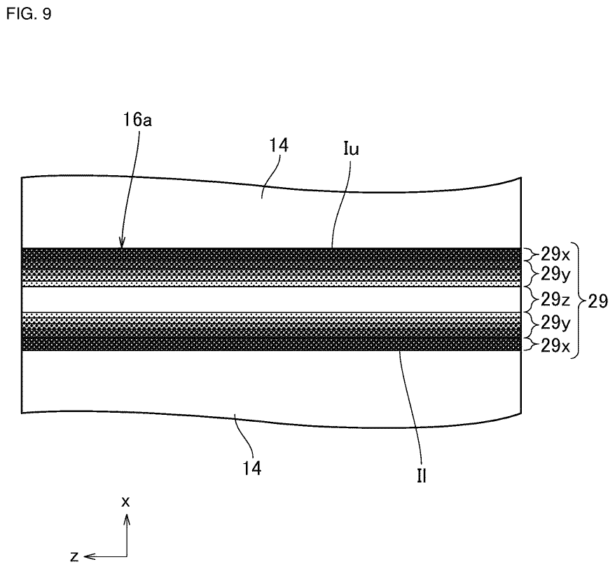

In the above description of the internal electrode layer 16, the interface layer 29x is defined by a portion including the surface defining the interface Iu with the dielectric layer 14 stacked in the upper portion of the first internal electrode layer 16a, as in the first internal electrode layer 16a illustrated in FIG. 6, but the first internal electrode layer 16a may be defined by a portion including the surface and the back surface defining the interfaces Iu and Il with the pair of dielectric layers 14 stacked above and below the portion, respectively, to define a pair of interface layers 29x, as illustrated in FIG. 9. In this case, a portion sandwiched between the pair of interface layers 29x and located at the center or approximate center of the first internal electrode layer 16a along the height direction x forms the electrode body layer 29z. Further, a pair of intermediate layers 29y is provided between each of the pair of interface layers 29x and the electrode body layer 29z, the intermediate layers 29y being layers in which the content of the rare earth oxide layer decreases as the distance from the interface layers 29x increases and the distance to the electrode body layer 29z decreases.

This makes it possible to improve the insulation performance of each of the dielectric layers 14 sandwiched between the first and second internal electrode layers 16a and 16b in the multilayer body 12 from both the front and back surfaces thereof, and to more efficiently reduce or prevent the decrease in the reliability of the dielectric layers 14.

Further, the interface layer 29x may be provided as a portion including the surface forming the interface Il with the dielectric layer 14 stacked in the lower portion of the first internal electrode layer 16a, contrary to the example illustrated in FIG. 6.

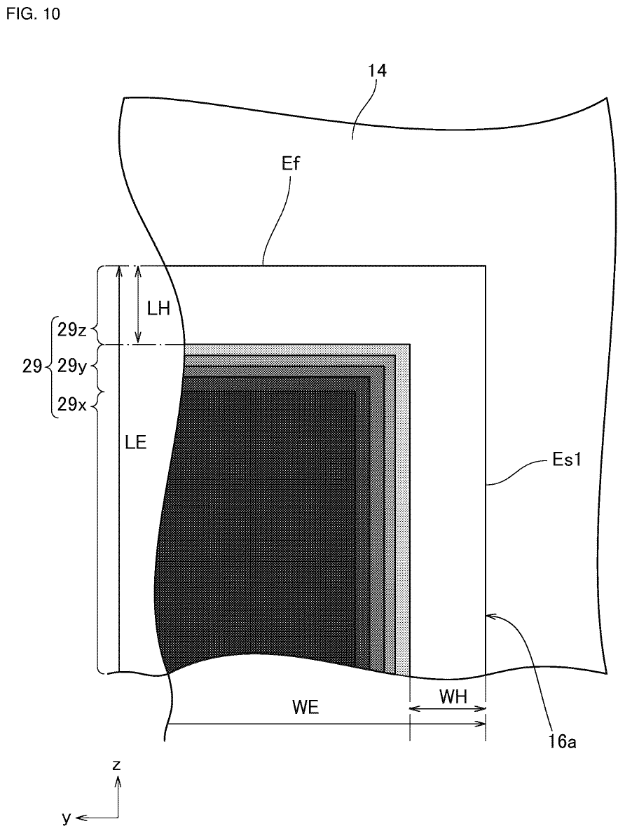

Additionally, in the above description, the first internal electrode layer 16a has the configuration in which the outline portion is defined by only the electrode body layer 29z and the remaining portion located closer to the center than the outline portion is defined by the stacking of the interface layer 29x and the electrode body layer 29z on the LW plane in the multilayer body 12, as in the first internal electrode layer 16a illustrated in FIG. 7 and FIG. 8, but the first internal electrode layer 16a may have a configuration in which the intermediate layer 29y is sandwiched between the interface layer 29x and the electrode body layer 29z as illustrated in FIG. 10. In this case, the intermediate layer 29y is a layer in which the content of the rare earth oxides decreases as the distance from the interface layer 29x increases and the distance to the electrode body layer 29z decreases along each of the length direction z and the width direction y.

Thus, each electrode layer of the internal electrode layers 16 can absorb oxygen vacancies not only in the boundary portion between the dielectric layer 14 and the internal electrode layer 16 but also in the inside thereof, and as a result, it is possible to reduce or prevent a decrease in the insulation resistance of the dielectric layer 14 and reduce or prevent a decrease in reliability while ensuring the inherent conductivity of the internal electrode layer 16. In FIG. 10, the intermediate layer 29y is shown by a stepwise change in color shade, but the distribution of the rare earth oxide layers in the intermediate layer 29y has a continuous change.

As described above, in the multilayer ceramic capacitor 10 according to the first example embodiment of the present invention, the first internal electrode layers 16a and the second internal electrode layers 16b of the internal electrode layers 16 include rare earth oxides distributed along the interfaces with the dielectric layers 14, such that it is possible to reduce or prevent a decrease in reliability due to oxygen vacancies.

Next, as illustrated in FIG. 1 to FIG. 4, the outer electrode 30 is provided on the first side surface 12c and the second side surface 12d, and the first end surface 12e side and the second end surface 12f side of the multilayer body 12.

The outer electrode 30 includes a first outer electrode 30a and a second outer electrode 30b.

The first outer electrode 30a is electrically connected to the first internal electrode layers 16a and disposed on the surface of the first end surface 12e. In addition, the first outer electrode 30a extends from the first end surface 12e of the multilayer body 12 along the outline of the multilayer body 12 and is disposed on a portion of the first main surface 12a and a portion of the second main surface 12b and also on a portion of the first side surface 12c and a portion of the second side surface 12d. The first outer electrode 30a is provided on at least the surface of the first end surface 12e and is preferably disposed on a portion of the first main surface 12a and a portion of the second main surface 12b. The first outer electrode 30a is preferably arranged so as to further extend to some extent around a portion of the first side surface 12c and a portion of the second side surface 12d.

The second outer electrode 30b is electrically connected to the second internal electrode layer 16b and disposed on the surface of the second end surface 12f. In addition, the second outer electrode 30b extends from the second end surface 12f of the multilayer body 12 along the outline of the multilayer body 12 and is disposed on a portion of the first main surface 12a and a portion of the second main surface 12b and also on a portion of the first side surface 12c and a portion of the second side surface 12d. The second outer electrode 30b is provided on at least the surface of the second end surface 12f and is preferably disposed on a portion of the first main surface 12a and a portion of the second main surface 12b. The second outer electrode 30b is preferably arranged so as to further extend to some extent around a portion of the first side surface 12c and a portion of the second side surface 12d.

The outer electrode 30 preferably includes, as an example of the internal structure, an underlying electrode layer 32 including a metal component and a ceramic component, and a plating layer 34 disposed on the surface of the underlying electrode layer 32.

The underlying electrode layer includes a first underlying electrode layer 32a in the first outer electrode 30a and a second underlying electrode layer 32b in the second outer electrode 30b.

The underlying electrode layer 32 preferably includes, for example, at least one layer selected from a baked layer, a conductive resin layer, and a thin film layer. The baked layer as the underlying electrode layer will be described below.

The baked layer is formed by applying a conductive paste including a glass component and a metal to the multilayer body 12 and baking the conductive paste. The glass component of the baked layer includes, for example, at least one of B, Si, Ba, Mg, Al, Li, and the like. The metal of the baked layer includes, for example, at least one of Cu, Ni, Ag, Pd, an Ag—Pd alloy, Au, and the like.

The baked layer may be obtained by, for example, simultaneously firing a multilayer chip including the internal electrode layers 16 and the dielectric layers 14, which is a base of the multilayer body 12, and a conductive paste applied to the multilayer chip. In addition, the baked layer may be obtained by, for example, firing the multilayer chip to obtain the multilayer body 12, and then applying a conductive paste to the multilayer body 12 and baking the conductive paste. When the multilayer chip and the conductive paste applied to the multilayer chip are fired at the same time, the baked layer to which a dielectric material is added, instead of the glass component, is preferably used. The baked layer include a single layer or a plurality of layers.

When the first and second underlying electrode layers 32a and 32b are formed as baked layers, the thickness thereof is preferably about 5 μm or more and about 30 μm or less, for example. However, the thickness of the baked layer means the L dimension at the central portion in the height direction x on the first end surface 12e or the second end surface 12f, the T dimension at the central portion in the length direction z on the first main surface 12a or the second main surface 12b, and the W dimension at the central portion in the length direction z on the first side surface 12c or the second side surface 12d.

Next, the conductive resin layer as the underlying electrode layer 32 will be described. When the conductive resin layer is used as the underlying electrode layer 32, the conductive resin layer may be disposed directly on the multilayer body 12, or may be disposed so as to further cover a baked layer or another material layer that is provided as a portion of the underlying electrode layer 32.

In this case, the conductive resin layer may completely cover the baked layer or the other material layer, or may cover a portion thereof. Specifically, each of the first and second underlying electrode layers 32a and 32b as the conductive resin layer is preferably provided to extend from a portion of the underlying electrode layer 32 located on each of the first and second end surfaces 12e and 12f to a portion located on each of the first and second main surfaces 12a and 12b and each of the first and second side surfaces 12c and 12d. Alternatively, each of the first and second underlying electrode layers 32a and 32b as the conductive resin layer may be provided only on the portions located on first and second end surfaces 12e and 12f.

Furthermore, the thickness of the conductive resin layer is preferably, for example, about 5 μm or more and about 30 μm or less. The definition of the thickness of the conductive resin layer is the same as that of the baked layer described above.

The material of the conductive resin layer includes, for example, a metal component such as conductive particles and a thermosetting resin. The conductive resin layer includes a thermosetting resin, and thus is more flexible than a conductive layer made of, for example, a plating film or a fired product of a conductive paste. Therefore, even when a physical impact or an impact caused by a thermal cycle is applied to the multilayer ceramic capacitor 10, the conductive resin layer defines and functions as a buffer layer, and thus, cracks in the multilayer ceramic capacitor 10 can be reduced or prevented.

Next, as a resin suitable for the conductive resin layer, for example, various known thermosetting resins such as an epoxy resin, a phenol resin, a urethane resin, a silicone resin, and a polyimide resin can be used. Among these, epoxy resin is one of the most suitable resins because of its excellent heat resistance, moisture resistance, close contact performance, etc.

Further, the conductive resin layer preferably includes a curing agent together with the thermosetting resin. When an epoxy resin is used as the thermosetting resin defining and functioning as the base, various known compounds such as, for example, phenol compounds, amine compounds, acid anhydride compounds, imidazole compounds, active ester compounds, and amideimide compounds can be used as the curing agent.

Further, the resin included in the conductive resin layer is, for example, preferably included in an amount of about 25 vol % or more and about 65 vol % or less with respect to the volume of the entire conductive resin.

On the other hand, the metal as the conductive particles included in the conductive resin layer mainly functions to provide the conductivity of the conductive resin layer. Specifically, the conductive fillers are brought into contact with each other, and thus a conductive path is provided inside the conductive resin layer.

The metal included in the conductive resin layer is, for example, preferably included in a proportion of about 35 vol % or more and about 75 vol % or less with respect to the volume of the entire conductive resin.

As for the metal as the conductive particles included in the conductive resin layer, for example, Ag, Cu, or an alloy including all or a portion of these metals can be used.

Further, as the conductive particles, for example, metal particles coated with Ag on the surface thereof can also be used. In this case, for example, Cu or Ni is preferably used as the metal. The reason why the metal coated with Ag as the conductive particles is used is that Ag is suitable for an electrode material because it has the lowest specific resistance among metals, and is not oxidized and has high weather resistance because it is a noble metal. Also, it is possible to use a less expensive metal as the base material while maintaining the above-described characteristics of Ag.

Further, for example, as the metal included in the conductive resin layer, Cu subjected to an antioxidation treatment can also be used.

Next, the outer shape of the metal included in the conductive resin layer is not particularly limited, and a metal having a spherical shape, a flat shape, or the like can be used. Especially in this case, it is preferable to use a mixture of spherical metal powder and flat metal powder. The shape of the conductive filler may be spherical, flat, or the like. Further, the average particle diameter of the metal included in the conductive resin layer is not particularly limited. The average particle diameter of the conductive filler may be, for example, about 0.3 μm or more and about 10 μm or less. Further, the conductive resin layer may include a single layer or a plurality of layers.

Next, the thin film layer as the underlying electrode layer will be described. When the underlying electrode layer is provided as a thin film layer, the thin film layer is provided as a layer having an average thickness of, for example, about 1 μm or less by deposition of metal particles.

Next, the plating layer will be described. The plating layers include a first plating layer 34a in the first outer electrode 30a and a second plating layer 34b in the second outer electrode 30b. As illustrated in FIG. 2 to FIG. 4, the plating layer 34 covers the entire or substantially the entire surface of the underlying electrode layer 32 so that the underlying electrode layer 32 is not exposed to the outside. Specifically, each of the first plating layer 34a and the second plating layer 34b is preferably provided to extend from portions of the first underlying electrode layer 32a and the second underlying electrode layer 32b located on each of the first end surface 12e and the second end surface 12f to portions of the first underlying electrode layer 32a and the second underlying electrode layer 32b located on each of the first main surface 12a and the second main surface 12b and each of the first side surface 12c and the second side surface 12d. Alternatively, the first plating layer 34a and the second plating layer 34b may be provided at portions of the first underlying electrode layer 32a and the second underlying electrode layer 32b located only on the first end surface 12e and the second end surface 12f, respectively.

The plating layer 34 may include at least one metal selected from, for example, Cu, Ni, Sn, Ag, Pd, an Ag—Pd alloy, Au, and the like.

The plating layer 34 may include a single layer or a plurality of layers. When the plating layer includes a plurality of layers, for example, a two-layer structure of Ni plating and Sn plating is preferable. By providing the layer in direct contact with the underlying electrode layer as a plating layer made of Ni plating, especially when the underlying electrode layer is a conductive resin layer, the underlying electrode layer can be prevented from being eroded by solder used for mounting the ceramic electronic component.

In addition, by providing the upper layer on the plating layer made of Ni plating as the plating layer made of Sn plating, when the multilayer ceramic capacitor 10 is mounted on a mounting substrate, the wettability of solder used for mounting is improved, and the mounting can be easily performed.

The thickness of each plating layer 34 is preferably about 4 μm or more and about 10 μm or less, for example.

The outer electrode 30 may include only the plating layer without the underlying electrode layer 32. In this case, the outer electrode 30 can be formed of a single plating layer by providing a catalyst on the surface of the multilayer body 12 as a pretreatment.

Even when the outer electrode 30 includes a single plating layer, it is preferable that the outer electrode 30 include a lower layer provided on the surface of the multilayer body 12 and an upper layer provided on the surface of the lower layer, as in the case where the underlying electrode layer 32 is provided. On the other hand, the upper layer may be provided as necessary, and the outer electrode 30 may include only the plating of the lower layer. As in the case described above, the upper layer and the lower layer preferably include at least one metal selected from Cu, Ni, Sn, Pb, Au, Ag, Pd, Bi, Zn, and the like, or an alloy including the metal, for example, and the lower layer is preferably made using Ni and the upper layer is preferably made using Sn or Au, for example. The reason why each metal is suitable is the same as the case described above.

For example, when the first internal electrode layers 16a and the second internal electrode layers 16b are made using Ni, the lower-layer plating electrode is preferably made using Cu, which has good bonding properties with Ni.

The plating layer disposed without the underlying electrode layer 32 includes an upper layer as the outermost layer, but may include another plating electrode provided on the surface of the upper layer.

The thickness of each plating layer disposed without the underlying electrode layer 32 is preferably about 4 μm or more and about 10 μm or less, for example. The plating layer preferably does not include glass. The metal ratio per unit volume of the plating layer is, for example, preferably about 99 vol % or more.

The dimension of the multilayer ceramic capacitor 10 including the multilayer body 12, the first outer electrode 30a, and the second outer electrode 30b in the length direction z is denoted by the L dimension, the dimension of the multilayer ceramic capacitor 10 including the multilayer body 12, the first outer electrode 30a, and the second outer electrode 30b in the height direction x is denoted by the T dimension, and the dimension of a multilayer ceramic capacitor 10 including the multilayer body 12, the first outer electrode 30a, and the second outer electrode 30b in the width direction y is denoted by the W dimension.

The dimensions of the multilayer ceramic capacitor 10 are, for example, such that the L dimension in the length direction z is about 0.4 mm or more and about 1.6 mm or less, the W dimension in the width direction y is about 0.2 mm or more and about 1.0 mm or less, and the T dimension in the height direction x is about 0.2 mm or more and about 1.0 mm or less. The dimensions of the multilayer ceramic capacitor 10 can be measured with a microscope.

In the two-terminal multilayer ceramic capacitor 10 illustrated in FIG. 1, as illustrated in FIG. 6, the first internal electrode layer 16a of the internal electrode layer 16 includes, for example, rare earth oxides in the interface layer 29x including the surface forming the interface Iu with the dielectric layer 14 stacked on the first internal electrode layer 16a, so that the oxygen vacancies moving from the dielectric layer 14 to the internal electrode layer 16 are absorbed by the rare earth oxides included in the interface layer 29x. Thus, in the dielectric layer in the vicinity of the interface Iu on the dielectric layer 14 side, accumulation of oxygen vacancies and electric field concentration caused thereby are reduced or prevented, and a decrease in insulation resistance can be reduced or prevented. As a result, the decrease in reliability of the dielectric layer 14 is reduced or prevented. On the other hand, for example, in the interface layer 29x, which is closer to the first internal electrode layer 16a than the interface Iu, the rare earth oxides absorb the oxygen vacancies and are reduced to rare earth elements, and the conductivity is secured.

As described above, in the multilayer ceramic capacitor 10 illustrated in FIG. 1, the decrease in the insulation resistance in the dielectric layer 14 is reduced or prevented based on the configuration of the internal electrode layer 16 side. Therefore, a material having the same composition as that of a conventional dielectric material can be used as the dielectric layer 14, and a decrease in the reliability of the dielectric layer 14 can be reduced or prevented with a low-cost configuration.

### 2. Method for Manufacturing Two-Terminal Multilayer Ceramic Capacitor

Next, an example of a method for manufacturing a two-terminal multilayer ceramic capacitor will be described.

### Preparation

First, dielectric sheets for the dielectric layers 14 and a conductive paste for the internal electrode layers are prepared. The dielectric sheets are prepared for the case where the first internal electrode layers 16a are disposed, the case where the second internal electrode layers 16b are disposed, and the case where no internal electrode layers are disposed. The dielectric sheet and the conductive paste for the internal electrode each include a binder and a solvent. The binder and the solvent may be known ones.

Here, two types of conductive pastes are used to obtain the first internal electrode layers 16a and the second internal electrode layers 16b in the completed multilayer ceramic capacitor 10. Specifically, for example, as in the conventional example, a conductive paste including a conductive material such as a metallic material (hereinafter referred to as a first conductive paste) and a conductive paste obtained by mixing and stirring rare earth oxides such as Dy₂O₃, Y₂O₃, La₂O₃, Nd₂O₃, and CeO₂ in the first conductive paste (hereinafter referred to as a second conductive paste) are used.

### Production of Stacked Sheet

Next, a conductive paste for the internal electrode layer is printed on the dielectric sheet in a predetermined pattern corresponding to each shape of the internal electrode layers 16 by a method such as, for example, printing using screen printing, gravure printing, or the like. Thus, the conductive paste is applied to the portion of the dielectric sheet on which a portion to be the first t internal electrode layer 16a is disposed (hereinafter, such a dielectric sheet is referred to as a first paste-applied dielectric sheet). In addition, the conductive paste is applied to the portion of the dielectric sheet on which the second internal electrode layer 16b is disposed (hereinafter, such a dielectric sheet is referred to as a second paste-applied dielectric sheet).

Specifically, taking screen-printing as an example, a screen plate for printing the first internal electrode layers 16a and a screen plate for printing the second internal electrode layers 16b are separately prepared, and a predetermined pattern corresponding to each of the internal electrode layers 16 can be printed by using a printing machine capable of printing these two types of screen plates on different dielectric sheets.

In this process, a step for obtaining the configuration in layers of each of the first internal electrode layers 16a and the second internal electrode layers 16b in the completed multilayer ceramic capacitor 10 is performed. Specifically, for example, a two-step application process is performed, which includes a first step of applying the first conductive paste to the surface of the dielectric sheet and a second step of applying the second conductive paste to the surface to which the first conductive paste has been applied, the second step being performed after the first step using the first conductive paste.

A three-step application process may be performed, which includes, for example, a first step using the first conductive paste, a second step using the second conductive paste performed after the first step using the first conductive paste, and further includes the first step of applying the first conductive paste to the surface to which the second conductive paste has been applied after the second step using the second conductive paste.

The first step using the first conductive paste is performed so as to form a shape (planar shape) of each of the first and second internal electrode layers 16a and 16b after completion, the shape being suitable for the shape when viewed in the height direction x.

Next, the dimensions of the application shape obtained by the second step using the second conductive paste with respect to the planar shape obtained by the first step using the first conductive paste in the length direction z and the width direction y are each preferably reduced by, for example, about 2% from the planar shape obtained by the first step using the first conductive paste. Thus, the electrode body layer 29z, in which no rare earth oxides are present in the outline as viewed in the height direction x, can be formed in each of the completed first and second internal electrode layers 16a and 16b.

On the other hand, the application shape by the second conductive paste may be the same as the planar shape obtained by the first step using the first conductive paste. The electrode body layer 29z in which no rare earth oxides are present at the edge portion as viewed in the height direction x can be formed in each of the completed first and second internal electrode layers 16a and 16b. Furthermore, the application shape of the second conductive paste with respect to the planar shape obtained by the first step using the first conductive paste may be such that the dimension in either the length direction z or the width direction y is reduced by, for example, about 2% from the planar shape obtained by the first step using the first conductive paste. In particular, it is preferable to reduce the larger one of the dimensions in the length direction z and the width direction y.

The physical thickness of the printing, i.e., the thickness of the surface with paste applied, in each of the first step using the first conductive paste and the second step using the second conductive paste may be arbitrary, but the thickness of the surface to which the second conductive paste is applied is, for example, preferably about 50% or less of the thickness of the surface to which the first conductive paste is applied.

In this way, the first paste-applied dielectric sheets and the second paste-applied dielectric sheets are stacked alternately or in a desired arrangement order, thus producing a stacked product including the inner layer portion 18. The second paste-applied dielectric sheet or the first paste-applied dielectric sheet, which has a surface with no conductive paste applied, is stacked in a surface-to-surface manner on the first paste-applied dielectric sheet or the second paste-applied dielectric sheet, which has the surface with the second conductive paste applied, so that the surface to which the second conductive paste is applied and the surface of the dielectric sheet are in contact with each other, thus obtaining the interlayer structure along the height direction x as illustrated in FIG. 6 or FIG. 9.

Subsequently, a predetermined number of dielectric sheets for outer layers on which the patterns of the internal electrode layers are not printed are stacked, thus forming a portion to be the second main-surface-side outer layer portion 20b on the second main surface 12b side. Then, the dielectric sheets on which the patterns of the first internal electrode layers are printed and the dielectric sheets on which the patterns of the second internal electrode layers are printed are sequentially stacked on the portion to be the above second main-surface-side outer layer portion 20b so as to obtain the structure of the present invention, thus forming a portion to be the inner layer portion 18. Thereafter, a predetermined number of dielectric sheets for outer layers on which the patterns of the internal electrode layers are not printed are further stacked on the portion to be the inner layer portion 18, thereby forming a portion to be the first main-surface-side outer layer portion 20a on the first main surface 12a side. Thus, a stacked sheet is produced.

In the above description, the first step of applying the first conductive paste corresponds to the first step, and the second step of applying the second conductive paste corresponds to the second step, thus these steps correspond to the application step. The step of stacking the first paste-applied dielectric sheets and the second paste-applied dielectric sheets alternately or in a desired arrangement order corresponds to the stacking step.

As the two-step application process, the second step of applying the second conductive paste may be performed on the surface of the dielectric sheet, and the first step of applying the first conductive paste may be performed on the surface to which the first conductive paste is applied. In this case, the surface to which the second conductive paste is applied and the surface of the dielectric sheet are brought into contact with each other by the step of applying the conductive paste, and the interlayer structure along the height direction x as illustrated in FIG. 6 or FIG. 9 can be obtained.

That is, the method for manufacturing a multilayer ceramic capacitor is not limited by the order of performing the first step and the second step and the application targets of the first step and the second step as long as the surface, to which the second conductive paste is applied, obtained by the second step of applying the second conductive paste and the surface of the dielectric sheet can be brought into contact with each other in the manufactured stacked sheet.

### Production of Laminated Block

Next, the stacked sheet is pressed in the stacking direction of the dielectric sheets by, for example, isostatic pressing or the like, thus producing a laminated block.

### Production of Multilayer Chip

The laminated block is cut into a predetermined size, such that a plurality of multilayer chips is cut out. At this time, corner portions and ridge portions of the multilayer chip may be rounded by, for example, barrel polishing or the like.

### Production of Multilayer Body

The multilayer chip is fired, and thus the multilayer body 12 is produced. The firing temperature depends on the material of the dielectric sheet and the material of the internal electrode layer, but is, for example, preferably about 900° C. or more and about 1400° C. or less.

In the process of firing the multilayer chip, the rare earth oxides are diffused from the film of the second conductive paste applied with respect to the film of the first conductive paste applied, and thus the intermediate layer 29y illustrated in FIG. 6 or FIG. 9 is formed in the internal electrode layer 16 after firing. Note that, by adjusting the firing temperature and time of the multilayer chip, or the application thicknesses, compositions, and the like of the first conductive paste and the second conductive paste, a configuration in which the intermediate layer 29y is omitted is obtained in the internal electrode layers 16 after firing.

### Formation of Outer Electrode

### (a) Case of Baked Layer

In the following description, for example, the underlying electrode layer is formed of a baked layer. In the case of forming the baked layer, a conductive paste including a glass component and a metal is prepared, and the conductive paste is applied and then baked to form the underlying electrode layer.

The first underlying electrode layer 32a of the first outer electrode 30a and the second underlying electrode layer 32b of the second outer electrode 30b are formed on the first end surface 12e and the second end surface 12f of the multilayer body 12 obtained by firing.

In the case where a baked layer is formed as the underlying electrode layer 32, a conductive paste including a glass component and a metal component is applied by a method such as, for example, dipping, and then a baking process is performed, so that a baked layer is formed as the underlying electrode layer 32. The temperature of the baking process at this time is, for example, preferably about 700° C. or more and about 900° C. or less.

### (b) Case of Conductive Resin Layer

When the underlying electrode layer 32 is formed of a conductive resin layer, the conductive resin layer can be formed by the following method. The conductive resin layer may be formed on the surface of the baked layer, or the conductive resin layer alone may be directly formed on the multilayer body 12 without forming the baked layer.

The conductive resin layer is formed by applying a conductive resin paste including a thermosetting resin and a metal component onto the baked layer or the multilayer body 12, and performing a heat treatment at a temperature of, for example, about 250° C. or more and about 550° C. or less to thermally cure the resin. The atmosphere during the heat treatment is, for example, preferably a N₂ atmosphere. In order to prevent the resins from scattering and to prevent the various metal components from being oxidized, the concentration of oxygen is, for example, preferably controlled to about 100 ppm or less.

As a method of applying the conductive resin paste, for example, a method of applying the conductive paste by extruding the conductive paste from a slit or a roller transfer method can be used, as in the method of forming the underlying electrode layer of a baked layer.

### (c) Case of Thin Film Layer

When the underlying electrode layer 32 is formed of a thin film layer, for example, the underlying electrode layer can be formed by covering the portion other than the desired portion where the outer electrode 30 is to be formed by masking or the like and performing a thin film forming method such as a sputtering method or a vapor deposition method on the exposed desired portion. The underlying electrode layer formed of the thin film layer is a layer of 1 μm or less in which metal particles are deposited.

### Plating Electrode

Further, the outer electrode may be formed as a plating electrode, for example, only with a plating layer without providing the underlying electrode layer 32. In this case, the following method can be used.

One or both of the first and second outer electrodes 30a and 30b may include a plating layer directly formed on the surfaces of the multilayer body 12 without providing the underlying electrode layer 32. That is, the two-terminal multilayer ceramic capacitor 10 may have a structure including the plating layers electrically connected directly to the first internal electrode layers 16a and the second internal electrode layers 16b. In performing the plating treatment, either electrolytic plating or electroless plating may be used, but the electroless plating requires pretreatment with a catalyst or the like in order to improve the plating deposition rate, and thus has a disadvantage of complicating the process. Therefore, it is usually preferable to use the electrolytic plating. As the plating method, barrel plating is preferably used. If necessary, an upper-layer plating electrode formed on the surface of a lower-layer plating electrode may be formed in the same manner.

### Production of Plating Layer

Subsequently, a plating layer is formed on the surface of the underlying electrode layer 32, the surface of the conductive resin layer or the surface of the lower-layer plating electrode, and the surface of the upper-layer plating electrode, as necessary.

More specifically, in the present example embodiment, a Ni plating layer is formed as the plating layer 34 on the underlying electrode layer 32, which is a baked layer, and a Sn plating layer is formed as an upper-layer plating layer 36. The Ni plating layer and the Sn plating layer are sequentially formed by, for example, a barrel plating method. The plating treatment may be performed by using either electrolytic plating or electroless plating, for example. However, the electroless plating requires pretreatment with a catalyst or the like in order to improve the plating deposition rate, and thus has a disadvantage of complicating the process. Therefore, it is usually preferable to use the electrolytic plating.

In this way, the two-terminal multilayer ceramic capacitor of the first example embodiment is obtained.

### B. Second Example Embodiment

### 1. Three-terminal Multilayer Ceramic Capacitor

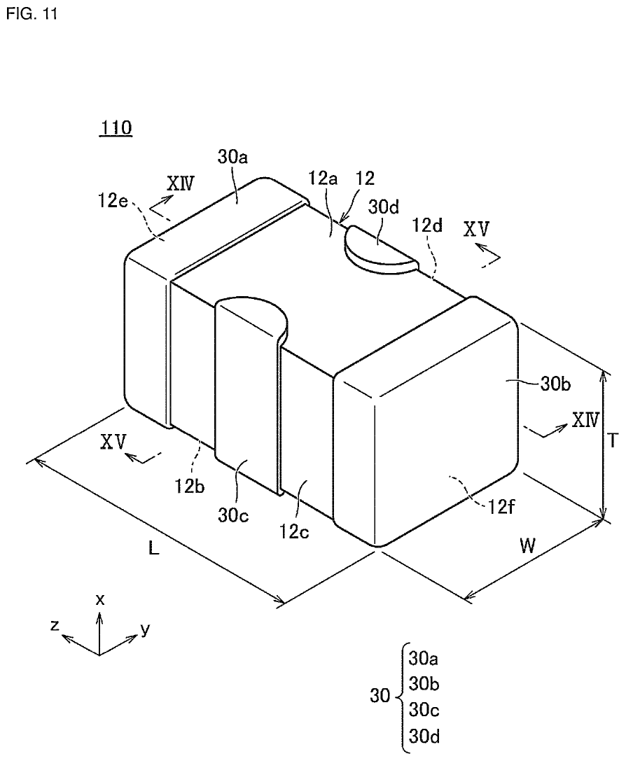

A three-terminal multilayer ceramic capacitor 110 as a multilayer ceramic capacitor according to a second example embodiment of the present invention will be described with reference to FIG. 11 to FIG. 17.

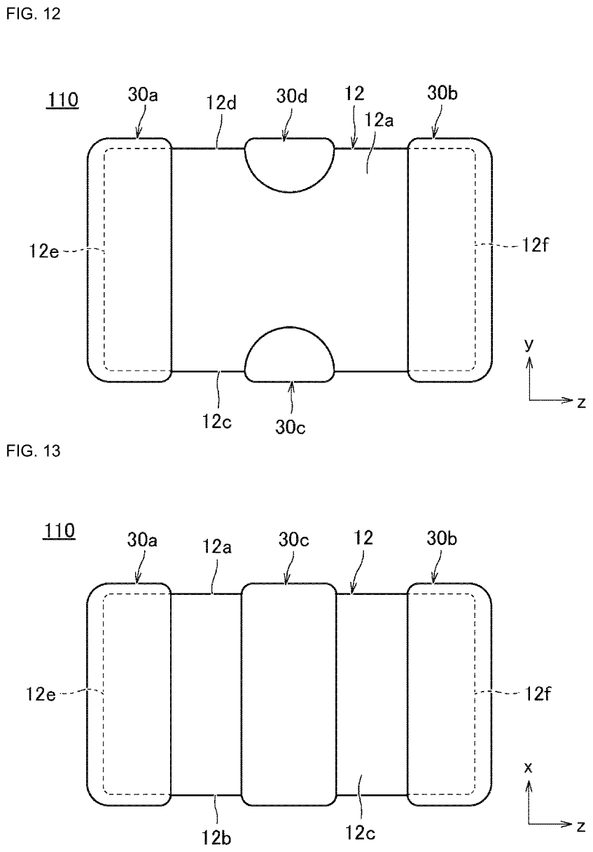

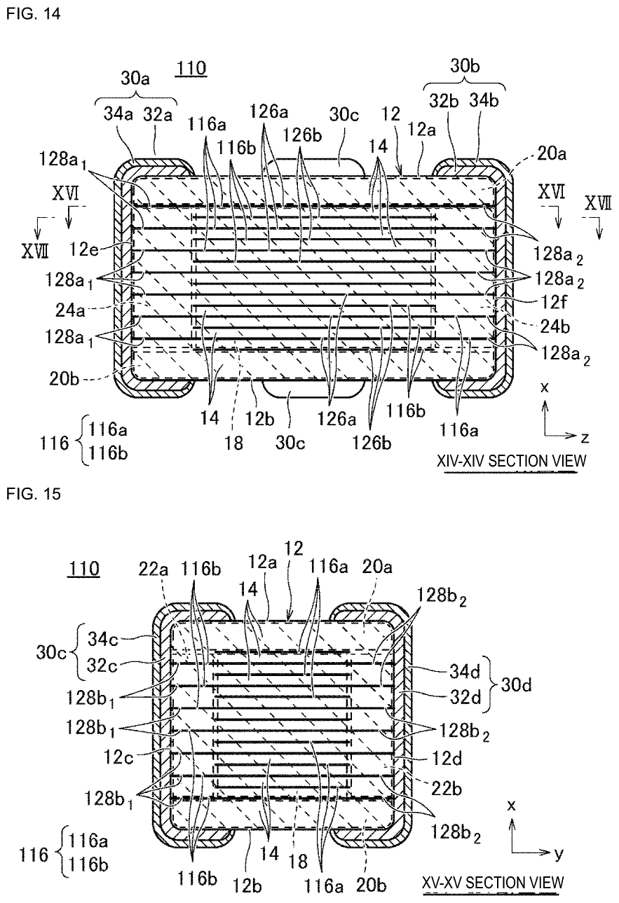

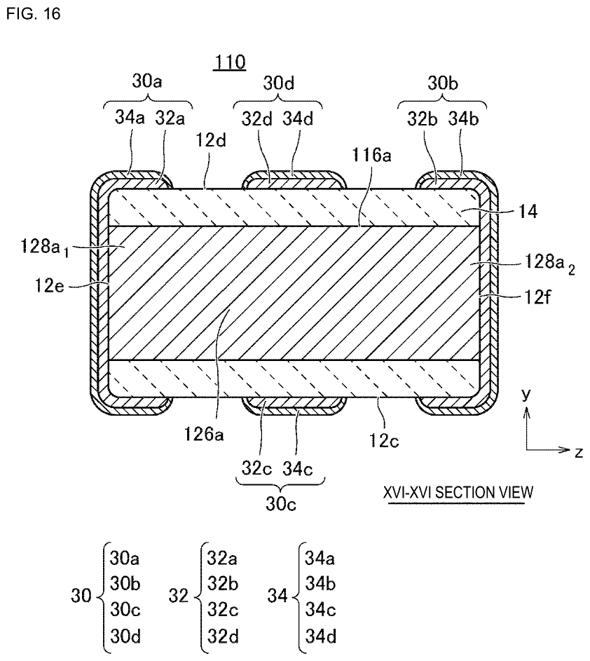

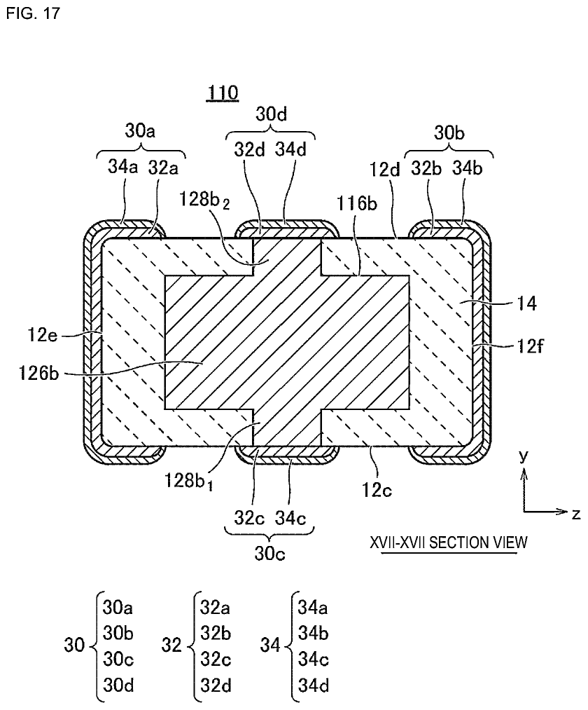

FIG. 11 is an external perspective view illustrating an example of the three-terminal multilayer ceramic capacitor according to the second example embodiment of the present invention. FIG. 12 is a top view illustrating an example of the three-terminal multilayer ceramic capacitor according to the second example embodiment of the present invention. FIG. 13 is a front view illustrating an example of the three-terminal multilayer ceramic capacitor according to the second example embodiment of the present invention. FIG. 14 is a cross-sectional view taken along line XIV-XIV in FIG. 11. FIG. 15 is a cross-sectional view taken along line XV-XV in FIG. 11. FIG. 16 is a cross-sectional view taken along line XVI-XVI in FIG. 14. FIG. 17 is a cross-sectional view taken along line XVII-XVII in FIG. 14.

The multilayer body 12 includes the plurality of stacked dielectric layers 14 and a plurality of internal electrode layers 116 stacked on the dielectric layers 14. The dielectric layers 14 and the internal electrode layers 116 are stacked in the height direction x.

The multilayer body 12 includes the first main surface 12a and the second main surface 12b opposed to each other in the height direction x, the first side surface 12c and the second side surface 12d opposed to each other in the width direction y orthogonal or substantially orthogonal to the height direction x, and the first end surface 12e and the second end surface 12f opposed to each other in the length direction z orthogonal or substantially orthogonal to the height direction x and the width direction y. The multilayer body 12 includes a rounded corner portion and a ridge portion. The corner portion is a portion where three adjacent surfaces of the multilayer body intersect each other, and the ridge portion is a portion where two adjacent surfaces of the multilayer body intersect each other. In addition, irregularities or the like may be provided in a portion or all of the first main surface 12a and the second main surface 12b, the first side surface 12c and the second side surface 12d, and the first end surface 12e and the second end surface 12f.

The multilayer body 12 includes the inner layer portion 18 including one or the plurality of dielectric layers 14 and the plurality of internal electrode layers 116 disposed thereon. The internal electrode layers 116 include first internal electrode layers 116a extended to the first end surface 12e and the second end surface 12f, and second internal electrode layers 116b extended to the second side surface 12c and the second side surface 12d, and in the inner layer portion 18, the plurality of first internal electrode layers 116a and the plurality of second internal electrode layers 116b face each other with the dielectric layers 14 interposed therebetween.

The multilayer body 12 includes the first main-surface-side outer layer portion 20a that is located on the first main surface 12a side and includes the plurality of dielectric layers 14 located between the first main surface 12a and the outermost surface of the inner layer portion 18 on the first main surface 12a side and on a straight line extending from the outermost surface.

Similarly, the multilayer body 12 includes the second main-surface-side outer layer portion 20b that is located on the second main surface 12b side and includes the plurality of dielectric layers 14 located between the second main surface 12b and the outermost surface of the inner layer portion 18 on the second main surface 12b side and on a straight line extending from the outermost surface.

The multilayer body 12 includes the first side-surface-side outer layer portion 22a that is located on the first side surface 12c side and includes the plurality of dielectric layers 14 located between the first side surface 12c and the outermost surface of the inner layer portion 18 on the first side surface 12c side.

Similarly, the multilayer body 12 includes the second side-surface-side outer layer portion 22b that is located on the second side surface 12d side and includes the plurality of dielectric layers 14 located between the second side surface 12d and the outermost surface of the inner layer portion 18 on the second side surface 12d side.

The multilayer body 12 further includes the first end-surface-side outer layer portion 24a that is located on the first end surface 12e side and includes the plurality of dielectric layers 14 located between the first end surface 12e and the outermost surface of the inner layer portion 18 on the first end surface 12e side.

Similarly, the multilayer body 12 includes the second end-surface-side outer layer portion 24b that is located on the second end surface 12f side and includes the plurality of dielectric layers 14 located between the second end surface 12f and the outermost surface of the inner layer portion 18 on the second end surface 12f.

The first main-surface-side outer layer portion 20a is located on the first main surface 12a side. The first main-surface-side outer layer portion 20a is an aggregate of the plurality of dielectric layers 14 located between the first main surface 12a and the internal electrode layer 116 closest to the first main surface 12a.

The second main-surface-side outer layer portion 20b is located on the second main surface 12b side. The second main-surface-side outer layer portion 20b is an aggregate of the plurality of dielectric layers 14 located between the second main surface 12b and the internal electrode layer 116 closest to the second main surface 12b.

The material of the dielectric layer 14 is the same as that of the multilayer ceramic capacitor 10, and thus the description thereof will be omitted.

The average thickness of the dielectric layer 14 in the height direction x after firing is also the same or substantially the same as that of the multilayer ceramic capacitor 10, and thus the description thereof will be omitted.

The multilayer body 12 includes the plurality of first internal electrode layers 116a and the plurality of second internal electrode layers 116b as the plurality of internal electrode layers 116. The plurality of first internal electrode layers 116a and the plurality of second internal electrode layers 116b are embedded so as to be alternately arranged at equal or substantially equal intervals along the height direction x of the multilayer body 12.

As illustrated in FIG. 16, the first internal electrode layers 116a include first opposing electrode portions 126a opposed to the second internal electrode layers 116b, one first extended electrode portions 128a1 extended from the first opposing electrode portions 126a to the surface of the first end surface 12e of the multilayer body 12, and the other first extended electrode portions 128a2 extended from the first opposing electrode portions 126a to the surface of the second end surface 12f of the multilayer body 12. Specifically, the one first extended electrode portions 128a1 are exposed at the surface of the first end surface 12e of the multilayer body 12, and the other first extended electrode portions 128a2 are exposed at the surface of the second end surface 12f of the multilayer body 12. Therefore, the first internal electrode layers 116a are not exposed at the surfaces of the first side surface 12c and the second side surface 12d of the multilayer body 12.

As illustrated in FIG. 17, the second internal electrode layers 116b are cross-shaped or substantially cross-shaped and include second opposing electrode portions 126b opposed to the first internal electrode layers 116a, one second extended electrode portions 128b1 extended from the second opposing electrode portions 126b to the surface of the first side surface 12c of the multilayer body 12, and the other second extended electrode portions 128b2 extended from the second opposing electrode portions 126b to the surface of the second side surface 12d of the multilayer body 12. Specifically, the one second extended electrode portions 128b1 are exposed at the surface of the first side surface 12c of the multilayer body 12, and the other second extended electrode portions 128b2 are exposed at the surface of the second side surface 12d of the multilayer body 12. Therefore, the second internal electrode layers 116b are not exposed at the surfaces of the first end surface 12e and the second end surface 12f of the multilayer body 12.

The four corner portions of the second opposing electrode portions 126b in the second internal electrode layers 116b are not chamfered, but may be chamfered. This can reduce or prevent the overlapping with the corners of the first opposing electrode portions 126a of the first internal electrode layers 116a, thus reducing or preventing electric field concentration. As a result, dielectric breakdown of the ceramic capacitor, which may occur due to the electric field concentration, can be reduced or prevented.

The shapes of the portions of the first and second internal electrode layers 116a and 116b as viewed in the height direction x may be changed in the same or substantially the same manner as the first and second internal electrode layers 16a and 16b of the two-terminal multilayer ceramic capacitor 10 of the first example embodiment.

The composition of the material of the first internal electrode layers 116a and the second internal electrode layers 116b and the composition in the layers in the height direction x are the same as those of the first internal electrode layers 16a and the second internal electrode layers 16b of the multilayer ceramic capacitor 10 of the first example embodiment.

The thickness of each of the first and second internal electrode layers 116a and 116b is not particularly limited, but is, for example, preferably about 0.4 μm or more and about 0.8 μm or less, for example.

The number of the first internal electrode layers 116a and the number of the second internal electrode layers 116b are not particularly limited, but are, for example, preferably 2 or more and 1000 or less in total.

The outer electrode 30 includes the first outer electrode 30a, the second outer electrode 30b, a third outer electrode 30c, and a fourth outer electrode 30d.

The first outer electrode 30a is connected to the first internal electrode layers 116a and disposed on the surface of the first end surface 12e. The first outer electrode 30a extends from the first end surface 12e of the multilayer body 12 and is disposed on a portion of the first main surface 12a and a portion of the second main surface 12b, and also on a portion of the first side surface 12c and a portion of the second side surface 12d. In this case, the first outer electrode 30a is electrically connected to the one first extended electrode portions 128a1 of the first internal electrode layers 116a.

The second outer electrode 30b is connected to the first internal electrode layers 116a and disposed on the surface of the second end surface 12f. The second outer electrode 30b extends from the second end surface 12f of the multilayer body 12 and is disposed on a portion of the first main surface 12a and a portion of the second main surface 12b, and also on a portion of the first side surface 12c and a portion of the second side surface 12d. In this case, the second outer electrode 30b is electrically connected to the other first extended electrode portions 128a2 of the first internal electrode layers 116a.

The third outer electrode 30c is connected to the second internal electrode layers 116b and disposed on the surface of the first side surface 12c. The third outer electrode 30c extends from the first side surface 12c of the multilayer body 12 and is also disposed on a portion of the first main surface 12a and a portion of the second main surface 12b. In this case, the third outer electrode 30c is electrically connected to the one second extended electrode portions 128b1 of the second internal electrode layers 116b.

The fourth outer electrode 30d is connected to the second internal electrode layers 116b and disposed on the surface of the second side surface 12d. The fourth outer electrode 30d extends from the second side surface 12d of the multilayer body 12 and is also disposed on a portion of the first main surface 12a and a portion of the second main surface 12b. In this case, the fourth outer electrode 30d is electrically connected to the other second extended electrode portions 128b2 of the second internal electrode layers 116b.

In the multilayer body 12, the first opposing electrode portions 126a of the first internal electrode layers 116a and the second opposing electrode portions 126b of the second internal electrode layers 116b opposed to each other with the dielectric layers 14 interposed therebetween, thus generating an electrostatic capacitance. Therefore, the electrostatic capacitance can be obtained between the first and second outer electrodes 30a and 30b connected to the first internal electrode layers 116a and the third and fourth outer electrodes 30c and 30d connected to the second internal electrode layers 116b, and the characteristics of the capacitor are exhibited.

The underlying electrode layer 32 includes the first underlying electrode layer 32a, the second underlying electrode layer 32b, a third underlying electrode layer 32c, and a fourth underlying electrode layer 32d.

The first underlying electrode layer 32a is connected to the first internal electrode layers 116a and disposed on the surface of the first end surface 12e. The first underlying electrode layer 32a extends from the first end surface 12e and is also disposed on a portion of the first main surface 12a, a portion of the second main surface 12b, a portion of the first side surface 12c, and a portion of the second side surface 12d. In this case, the first underlying electrode layer 32a is electrically connected to the one first extended electrode portions 128a1 of the first internal electrode layers 116a.

The second underlying electrode layer 32b is connected to the first internal electrode layers 116a and disposed on the surface of the second end surface 12f. The second underlying electrode layer 32b extends from the second end surface 12f and is also disposed on a portion of the first main surface 12a, a portion of the second main surface 12b, a portion of the first side surface 12c, and a portion of the second side surface 12d. In this case, the second underlying electrode layer 32b is electrically connected to the other first extended electrode portions 128a2 of the first internal electrode layers 116a.

The third underlying electrode layer 32c is connected to the second internal electrode layers 116b and disposed on the surface of the first side surface 12c. The third underlying electrode layer 32c extends from the first side surface 12c and is also disposed on a portion of the first main surface 12a and a portion of the second main surface 12b. In this case, the third underlying electrode layer 32c is electrically connected to the one second extended electrode portions 128b1 of the second internal electrode layers 116b.

The fourth underlying electrode layer 32d is connected to the second internal electrode layers 116b and disposed on the surface of the second side surface 12d. The fourth underlying electrode layer 32d extends from the second side surface 12d and is also disposed on a portion of the first main surface 12a and a portion of the second main surface 12b. In this case, the fourth underlying electrode layer 32d is electrically connected to the other second extended electrode portion 128b2 of the second internal electrode layers 116b.

The plating layer 34 includes the first plating layer 34a, the second plating layer 34b, a third plating layer 34c, and a fourth plating layer 34d.

The first plating layer 34a covers the surface of the first underlying electrode layer 32a.

The second plating layer 34b covers the surface of the second underlying electrode layer 32b.

The third plating layer 34c covers the surface of the third underlying electrode layer 32c.

The fourth plating layer 34d covers the surface of the fourth underlying electrode layer 32d.

The material compositions and the configurations in layers of the first, second, third, and fourth outer electrodes 30a, 30b, 30c, and 30d of the outer electrode 30 of the three-terminal multilayer ceramic capacitor 110 are the same as or similar to those of the first and second outer electrodes 30a and 30b of the outer electrode 30 of the two-terminal multilayer ceramic capacitor 10 of the first example embodiment.

The three-terminal multilayer ceramic capacitor 110 of the present example embodiment is characterized in that, in the above-described configuration, the plurality of first and second internal electrode layers 116a and 116b defining the internal electrode layers 116 have the material compositions, the configuration in layers in the height direction x, and the configuration on layers as viewed in the height direction x the same as or similar to the configuration of the first and second internal electrode layers 16a and 16b of the multilayer ceramic capacitor 10 of the first example embodiment.

As such, the three-terminal multilayer ceramic capacitor 110 of the present example embodiment includes the rare earth oxide distributed along the interface with the dielectric layer 14 as in the multilayer ceramic capacitor 10 of the first example embodiment, and thus, it is possible to reduce or prevent a decrease in reliability due to oxygen vacancies. The three-terminal multilayer ceramic capacitor 110 according to the present example embodiment may have various configurations the same as or similar to those of the multilayer ceramic capacitor 10 described in the first example embodiment, and provides various advantageous effects corresponding to the various configurations.

### 2. Method for Manufacturing Three-Terminal Multilayer Ceramic Capacitor

Next, an example of a method for manufacturing a three-terminal multilayer ceramic capacitor will be described.

### Preparation

First, dielectric sheets for the dielectric layers and a conductive paste for the internal electrode layers are prepared. The dielectric sheets are prepared for the case where the first internal electrode layers 116a are disposed, the case where the second internal electrode layers 116b are disposed, and the case where no internal electrode layers are disposed. The dielectric sheet and the conductive paste for the internal electrode layer include a binder and a solvent. The binder and the solvent may be known ones.

Here, two types of conductive pastes are used to obtain the first internal electrode layers 116a and the second internal electrode layers 116b in the completed three-terminal multilayer ceramic capacitor 110. Specifically, for example, as in the conventional example, a conductive paste including a conductive material such as a metallic material (hereinafter referred to as a first conductive paste) and a conductive paste obtained by mixing and stirring rare earth oxides such as Dy₂O₃, Y₂O₃, La₂O₃, Nd₂O₃, and CeO₂ in the first conductive paste (hereinafter referred to as a second conductive paste) are used.

### Production of Stacked Sheet

Next, a conductive paste for the internal electrode layers is printed on the dielectric sheets in a predetermined pattern corresponding to each shape of the internal electrode layers 116 by a method such as, for example, printing using screen printing, gravure printing, or the like. Thus, the conductive paste is applied to the portion of the dielectric sheet on which the portion to be the first internal electrode layer 116a is disposed (hereinafter, such a dielectric sheet is referred to as a first paste-applied dielectric sheet). In addition, the conductive paste is applied to the portion of the dielectric sheet on which the second internal electrode layer 116b is disposed (hereinafter, such a dielectric sheet is referred to as a second paste-applied dielectric sheet).

Specifically, taking screen-printing as an example, a screen plate for printing the first internal electrode layers 116a and a screen plate for printing the second internal electrode layers 116b are separately prepared, and a predetermined pattern corresponding to each of the internal electrode layers 116 can be printed by using a printing machine capable of printing these two types of screen plates on different dielectric sheets.

In this process, a step for obtaining the configuration in layers of each of the first internal electrode layers 116a and the second internal electrode layers 116b in the completed three-terminal multilayer ceramic capacitor 110 is performed. Specifically, for example, a two-step application process is performed, which includes a first step of applying the first conductive paste to the surface of the dielectric sheet and a second step of applying the second conductive paste to the surface to which the first conductive paste has been applied, the second step being performed after the first step using the first conductive paste.

A three-step application process may be performed, which include, for example, a first step using the first conductive paste, a second step using the second conductive paste performed after the first step using the first conductive paste, and further include the first step of applying the first conductive paste to the surface to which the second conductive paste has been applied after the second step using the second conductive paste.

The first step using the first conductive paste is performed so as to form a shape, which is suitable for the shape (planar shape) of each of the first and second internal electrode layers 116a and 116b after completion when viewed in the height direction x.

Next, the dimensions of the application shape obtained by the second step using the second conductive paste with respect to the planar shape obtained by the first step using the first conductive paste in the length direction z and the width direction y are each preferably reduced by, for example, about 2% from the planar shape obtained by the first step using the first conductive paste. Thus, the electrode body layer 29z, in which no rare earth oxides are present in the outline as viewed in the height direction x, can be formed in each of the completed first and second internal electrode layers 116a and 116b.

On the other hand, the application shape of the second conductive paste may be the same or substantially the same as the planar shape obtained by the first step using the first conductive paste. The electrode body layer 29z in which no rare earth oxides are present at the edge portion as viewed in the height direction x can be formed in each of the completed first and second internal electrode layers 116a and 116b. Furthermore, the application shape of the second conductive paste with respect to the planar shape obtained by the first step using the first conductive paste may be such that the dimension in either the length direction z or the width direction y is reduced by, for example, about 2% from the planar shape obtained by the first step using the first conductive paste. In particular, it is preferable to reduce the larger one of the dimensions in the length direction z and the width direction y.

The physical thickness of the printing, i.e., the thickness of the surface with paste applied, in each of the first step using the first conductive paste and the second step using the second conductive paste may be arbitrary, but the thickness of the surface to which the second conductive paste is applied is, for example, preferably about 50% or less of the thickness of the surface to which the first conductive paste is applied.

In this way, the first paste-applied dielectric sheets and the second paste-applied dielectric sheets are stacked alternately or in a desired arrangement order, thus producing a stacked product including the inner layer portion 18. The second paste-applied dielectric sheet or the first paste-applied dielectric sheet, which includes a surface with no conductive paste applied, is stacked in a surface-to-surface manner on the first paste-applied dielectric sheet or the second paste-applied dielectric sheet, which includes the surface with the second conductive paste applied, so that the surface to which the second conductive paste is applied and the surface of the dielectric sheet are in contact with each other, thus obtaining the interlayer structure along the height direction x as illustrated in FIG. 6 or FIG. 9.

Subsequently, a predetermined number of dielectric sheets for outer layers on which the patterns of the internal electrode layers are not printed are stacked, thus forming a portion to be the second main-surface-side outer layer portion 20b on the second main surface 12b side. Then, the dielectric sheets on which the patterns of the first internal electrode layers are printed and the dielectric sheets on which the patterns of the second internal electrode layers are printed are sequentially stacked on the portion to be the above second main-surface-side outer layer portion 20b so as to obtain the structure of the present invention, thereby forming a portion to be the inner layer portion 18. Thereafter, a predetermined number of dielectric sheets for outer layers on which the patterns of the internal electrode layers are not printed are further stacked on the portion to be the inner layer portion 18, thus forming a portion to be the first main-surface-side outer layer portion 20a on the first main surface 12a side. Thus, a stacked sheet is produced.

In the above description, the first step of applying the first conductive paste corresponds to the first step, and the second step of applying the second conductive paste corresponds to the second step, thus these steps correspond to the application step. The step of stacking the first paste-applied dielectric sheets and the second paste-applied dielectric sheets alternately or in a desired arrangement order corresponds to the stacking step.

As the two-step application process, the second step of applying the second conductive paste may be performed on the surface of the dielectric sheet, and the first step of applying the first conductive paste may be performed on the surface to which the first conductive paste is applied. In this case, the surface to which the second conductive paste is applied and the surface of the dielectric sheet are brought into contact with each other by the step of applying the conductive paste, and the interlayer structure along the height direction x as illustrated in FIG. 6 or FIG. 9 can be obtained.

That is, the method for manufacturing a multilayer ceramic capacitor is not limited by the order of performing the first step and the second step and the application targets of the first step and the second step as long as the surface, to which the second conductive paste is applied, obtained by the second step of applying the second conductive paste and the surface of the dielectric sheet can be brought into contact with each other in the manufactured stacked sheet.

### Production of Laminated Block

Next, the stacked sheet is pressed in the stacking direction of the dielectric sheets by, for example isostatic pressing or the like, thus producing a laminated block.

### Production of Multilayer Chip

The laminated block is cut into a predetermined size, such that a multilayer chip is cut out. At this time, corner portions and ridge portions of the multilayer chip may be rounded by, for example, barrel polishing or the like.

### Production of Multilayer Body

The multilayer chip is fired, and thus the multilayer body 12 is produced. The firing temperature depends on the material of the dielectric sheet and the material of the internal electrode layer, but is, for example, preferably about 900° C. or more and about 1400° C. or less.

In the process of firing the multilayer chip, the rare earth oxides are diffused from the film of the second conductive paste applied with respect to the film of the first conductive paste applied, and thus the intermediate layer 29y illustrated in FIG. 6 or FIG. 9 is formed in the internal electrode layer 116 after firing. By adjusting the firing temperature and time of the multilayer chip, or the application thicknesses, compositions, and the like of the first conductive paste and the second conductive paste, a configuration in which the intermediate layer 29y is omitted is obtained in the internal electrode layers 116 after firing.

### Formation of Outer Electrode

### (a) Case of Baked Layer

In the following description, the underlying electrode layer is formed of a baked layer. In the case of forming the baked layer, a conductive paste including a glass component and a metal is prepared, and the conductive paste is applied and then baked to form the underlying electrode layer.

The third underlying electrode layer 32c of the third outer electrode 30c is formed on the first side surface 12c of the multilayer body 12 obtained by firing, and the fourth underlying electrode layer 32d of the fourth outer electrode 30d is formed on the second side surface 12d of the multilayer body 12.

In the case where a baked layer is formed as the underlying electrode layer 32, a conductive paste including a glass component and a metal component is applied, and then a baking process is performed, so that a baked layer is formed as the underlying electrode layer 32. The temperature of the baking process at this time is, for example, preferably about 700° C. or more and about 900° C. or less.

Here, various methods can be used as a method for forming the baked layer. For example, a method of applying the conductive paste by extruding the conductive paste from a slit can be used. In this method, by increasing the amount of the conductive paste extruded, the underlying electrode layer 32 can be formed not only on the first side surface 12c and the second side surface 12d but also on a portion of the first main surface 12a and a portion of the second main surface 12b.

Alternatively, for example, the baked layer may be formed by a roller transfer method. In the case of the roller transfer method, when the underlying electrode layer 32 is formed not only on the first side surface 12c and the second side surface 12d but also on a portion of the first main surface 12a and a portion of the second main surface 12b, the underlying electrode layer 32 can be formed on a portion of the first main surface 12a and a portion of the second main surface 12b by increasing the pressing force during the roller transfer.

Next, the first underlying electrode layer 32a of the first outer electrode 30a is formed on the first end surface 12e of the multilayer body 12 obtained by firing, and the second underlying electrode layer 32b of the second outer electrode 30b is formed on the second end surface 12f of the multilayer body 12.

As in the case of forming the underlying electrode layer 32 of each of the third and fourth outer electrodes 30c and 30d, when a baked layer is formed as the underlying electrode layer 32, a conductive paste including a glass component and a metal component is applied, and then a baking process is performed to form the baked layer as the underlying electrode layer 32. The temperature of the baking process at this time is, for example preferably about 700° C. or more and about 900° C. or less.

The baked layer as the underlying electrode layer 32 of each of the first and second outer electrodes 30a and 30b is formed by, for example, a dip method with a conductive paste for the underlying electrode layer so as to extend not only to the first and second end surfaces 12e and 12f but also to a portion of the first main surface 12a, a portion of the second main surface 12b, a portion of the first side surface 12c, and a portion of the second side surface 12d.

The baking process may be performed on the third underlying electrode layer 32c of the third outer electrode 30c, the fourth underlying electrode layer 32d of the fourth outer electrode 30d, the first underlying electrode layer 32a of the first outer electrode 30a, and the second underlying electrode layer 32b of the second outer electrode 30b at the same time, but may be performed on the third underlying electrode layer 32c of the third outer electrode 30c, the fourth underlying electrode layer 32d of the fourth outer electrode 30d, the first underlying electrode layer 32a of the first outer electrode 30a, and the second underlying electrode layer 32b of the second outer electrode 30b separately.

### (b) Case of Conductive Resin Layer

When the underlying electrode layer 32 is formed of a conductive resin layer, the conductive resin layer can be formed by, for example, the following method. The conductive resin layer may be formed on the surface of the baked layer, or the conductive resin layer alone may be directly formed on the multilayer body 12 without forming the baked layer.

The conductive resin layer is formed by applying a conductive resin paste including a thermosetting resin and a metal component onto the baked layer or the multilayer body 12, and performing the heat treatment at a temperature of, for example, about 250° C. or more and about 550° C. or less to thermally cure the resin. The atmosphere during the heat treatment is, for example, preferably a N₂ atmosphere. In order to prevent the resins from scattering and to prevent the various metal components from being oxidized, the concentration of oxygen is, for example, preferably controlled to about 100 ppm or less.

As a method of applying the conductive resin paste, for example, a method of applying the conductive resin paste by extruding the conductive resin paste from a slit or a roller transfer method can be used, as in the method of forming the underlying electrode layer 32 as a baked layer.

### (c) Case of Thin Film Layer

When the underlying electrode layer 32 is formed of a thin film layer, the underlying electrode layer can be formed by covering the portion other than the desired portion where the outer electrode 30 is to be formed by, for example, masking or the like and performing a thin film forming method such as a sputtering method or a vapor deposition method on the exposed desired portion. The underlying electrode layer formed of the thin film layer is a layer of, for example, about 1 μm or less in which metal particles are deposited.

### Plating Electrode

Further, the outer electrode may be formed as a plating electrode only including a plating layer without providing the underlying electrode layer 32. In this case, for example, the following method can be used.

One or each of the first to fourth outer electrodes 30a to 30d may include a plating layer directly formed on the surfaces of the multilayer body 12 without providing the underlying electrode layer 32. That is, the three-terminal multilayer ceramic capacitor 110 may have a structure including the plating layer that is electrically connected directly to the first internal electrode layers 116a and the second internal electrode layers 116b. In performing the plating treatment, either electrolytic plating or electroless plating may be used, but electroless plating requires pretreatment with a catalyst or the like in order to improve the plating deposition rate, and thus has a disadvantage of complicating the process. Therefore, it is usually preferable to use the electrolytic plating. As the plating method, for example, barrel plating is preferably used. If necessary, an upper-layer plating electrode formed on the surface of a lower-layer plating electrode may be formed in the same or substantially the same manner.

### Production of Plating Layer

Subsequently, a plating layer is formed on the surface of the underlying electrode layer 32, the surface of the conductive resin layer or the surface of the lower-layer plating electrode, and the surface of the upper-layer plating electrode, as necessary.

More specifically, for example, in the present example embodiment, a Ni plating layer is formed as the plating layer 34 on the underlying electrode layer 32, which is a baked layer, and a Sn plating layer is formed as the upper-layer plating layer 36. The Ni plating layer and the Sn plating layer are sequentially formed by, for example, a barrel plating method. The plating treatment may be performed by using either electrolytic plating or electroless plating. However, the electroless plating requires pretreatment with a catalyst or the like in order to improve the plating deposition rate, and thus has a disadvantage of complicating the process. Therefore, it is usually preferable to use the electrolytic plating.

In this way, the three-terminal multilayer ceramic capacitor 110 according to the present example embodiment is manufactured.

Although the example embodiments of the present invention have been described in the above descriptions, the present invention is not limited to these example embodiments.

That is, in each of the above-described example embodiments, the two-terminal multilayer ceramic capacitor 10 or the three-terminal multilayer ceramic capacitor 110 has the configuration in which the internal electrode layer 16 include the intermediate layer 29y provided between the interface layer 29x and the electrode body layer 29z, but the intermediate layer 29y may be omitted.

In the above-described example embodiments, the two-terminal multilayer ceramic capacitor 10 and the three-terminal multilayer ceramic capacitor 110 are described, but the multilayer ceramic capacitor of the present invention is not limited to these configurations. In short, the multilayer ceramic capacitor is not limited by other specific configurations, for example, the number, shape, and the like of the multilayer body, the outer electrodes, and the internal electrode layers connected to the outer electrodes, as long as the multilayer ceramic capacitor include the multilayer body including the plurality of internal electrode layers arranged to face each other and to be spaced apart from each other and the dielectric layers including a ceramic material disposed between the plurality of internal electrode layers.

The present invention including the above description can be variously modified in the configuration, shape, material, quantity, position, arrangement, and the like with respect to the above-described example embodiments without departing from the scope of the technical idea and object of the present invention, and such modifications are included in the present invention.

Example embodiments of the present invention as described above have been developed in view of the problems described above, and achieve advantageous effects such that it is possible to reduce or prevent a decrease in reliability due to oxygen vacancies, and are applicable to, for example, multilayer ceramic capacitors.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of stacked dielectric layers and a plurality of stacked internal electrode layers, and including a first main surface and a second main surface opposed to each other in a height direction, a first side surface and a second side surface opposed to each other in a width direction orthogonal or substantially orthogonal to the height direction, and a first end surface and a second end surface opposed to each other in a length direction orthogonal or substantially orthogonal to the height direction and the width direction; and
a plurality of outer electrodes; wherein
the plurality of internal electrode layers include:
first internal electrode layers alternately stacked with the plurality of dielectric layers and exposed at the first end surface; and
second internal electrode layers alternately stacked with the plurality of dielectric layers and exposed at the second end surface;
the plurality of outer electrodes include:
a first outer electrode connected to the first internal electrode layers; and
a second outer electrode connected to the second internal electrode layers;
the first internal electrode layers and the second internal electrode layers include a rare earth oxide; and
the rare earth oxide in each of the first internal electrode layers and the second internal electrode layers is distributed along at least one of a pair of interfaces with the dielectric layer.

2. The multilayer ceramic capacitor according to claim 1, wherein the rare earth oxide in each of the first internal electrode layers and the second internal electrode layers is distributed along the height direction of the multilayer body of the first internal electrode layers and the second internal electrode layers so as to be most abundant at one of a pair of interfaces with the dielectric layer and decrease as a distance from the one of the pair of interfaces with the dielectric layer increases.

3. The multilayer ceramic capacitor according to claim 1, wherein the rare earth oxide in each of the first internal electrode layers and the second internal electrode layers is distributed along the height direction of the multilayer body of the first internal electrode layers and the second internal electrode layers so as to be most abundant at both of a pair of interfaces with the plurality of dielectric layers and decrease as a distance from both the pair of interfaces with the plurality of dielectric layers increases.

4. The multilayer ceramic capacitor according to claim 1, wherein the rare earth oxide in each of the first internal electrode layers and the second internal electrode layers is distributed so as to increase from a boundary with the dielectric layer toward a center when viewed in the height direction of the multilayer body of the first internal electrode layers and the second internal electrode layers.

5. The multilayer ceramic capacitor according to claim 1, wherein the rare earth oxide in each of the first internal electrode layers and the second internal electrode layers is not included in a portion of each of the first internal electrode layers and the second internal electrode layers along the length direction of the multilayer body, of an outline of each of the first internal electrode layers and the second internal electrode layers, when viewed in the height direction of the multilayer body of the first internal electrode layers and the second internal electrode layers.

6. The multilayer ceramic capacitor according to claim 5, wherein a ratio of a region not including the rare earth oxide in each of the first internal electrode layers and the second internal electrode layers and provided along an extending direction of each of the first internal electrode layers and the second internal electrode layers is about 2% or less of an entire dimension of each of the first internal electrode layers and the second internal electrode layers in the extending direction of each of the first internal electrode layers and the second internal electrode layers.

7. The multilayer ceramic capacitor according to claim 1, wherein the rare earth oxide in each of the first internal electrode layers and the second internal electrode layers is not included in a portion of each of the first internal electrode layers and the second internal electrode layers along a direction orthogonal or substantially orthogonal to the width direction of the multilayer body, of an outline of each electrode layer of the first internal electrode layers and the second internal electrode layers, when viewed in the height direction of the multilayer body of the first internal electrode layers and the second internal electrode layers.

8. The multilayer ceramic capacitor according to claim 7, wherein a ratio of a region not including the rare earth oxide in each of the first internal electrode layers and the second internal electrode layers and provided along a direction orthogonal to an extending direction of each of the first internal electrode layers and the second internal electrode layers is about 2% or less of an entire dimension of each of the first internal electrode layers and the second internal electrode layers in a direction orthogonal or substantially orthogonal to an extending direction of each of the first internal electrode layers and the second internal electrode layers.

9. The multilayer ceramic capacitor according to claim 1, wherein a content rate of the rare earth oxide in each of the first internal electrode layers and the second internal electrode layers is about 0.1 wt % or more and about 10 wt % or less, based on {(weight of rare earth oxide)/(weight of rare earth oxide+weight of main component metal of each of the first internal electrode layers and the second internal electrode layers)}×100.

10. A multilayer ceramic capacitor comprising:
a multilayer body including a plurality of stacked dielectric layers and a plurality of stacked internal electrode layers, and including a first main surface and a second main surface opposed to each other in a height direction, a first side surface and a second side surface opposed to each other in a width direction orthogonal or substantially orthogonal to the height direction, and a first end surface and a second end surface opposed to each other in a length direction orthogonal or substantially orthogonal to the height direction and the width direction; and
a plurality of outer electrodes; wherein
the plurality of internal electrode layers include:
first internal electrode layers alternately stacked with the plurality of dielectric layers and exposed at the first end surface and the second end surface; and
second internal electrode layers alternately stacked with the plurality of dielectric layers and exposed at the first side surface and second side surface;
the plurality of outer electrodes include:
a first outer electrode and a second outer electrode each connected to the first internal electrode layers; and
a third outer electrode and a fourth outer electrode each connected to the second internal electrode layers;
the first internal electrode layers and the second internal electrode layers include a rare earth oxide; and
the rare earth oxide in each of the first internal electrode layers and the second internal electrode layers is distributed along at least one of a pair of interfaces with the dielectric layer.

11. The multilayer ceramic capacitor according to claim 10, wherein the rare earth oxide in each of the first internal electrode layers and the second internal electrode layers is distributed along the height direction of the multilayer body of the first internal electrode layers and the second internal electrode layers so as to be most abundant at one of a pair of interfaces with the dielectric layer and decrease as a distance from the one of the pair of interfaces with the dielectric layer increases.

12. The multilayer ceramic capacitor according to claim 10, wherein the rare earth oxide in each of the first internal electrode layers and the second internal electrode layers is distributed along the height direction of the multilayer body of the first internal electrode layers and the second internal electrode layers so as to be most abundant at both of a pair of interfaces with the plurality of dielectric layers and decrease as a distance from both the pair of interfaces with the plurality of dielectric layers increases.

13. The multilayer ceramic capacitor according to claim 10, wherein the rare earth oxide in each of the first internal electrode layers and the second internal electrode layers is distributed so as to increase from a boundary with the dielectric layer toward a center when viewed in the height direction of the multilayer body of the first internal electrode layers and the second internal electrode layers.

14. The multilayer ceramic capacitor according to claim 10, wherein the rare earth oxide in each of the first internal electrode layers and the second internal electrode layers is not included in a portion of each of the first internal electrode layers and the second internal electrode layers along the length direction of the multilayer body, of an outline of each of the first internal electrode layers and the second internal electrode layers, when viewed in the height direction of the multilayer body of the first internal electrode layers and the second internal electrode layers.

15. The multilayer ceramic capacitor according to claim 14, wherein a ratio of a region not including the rare earth oxide in each of the first internal electrode layers and the second internal electrode layers and provided along an extending direction of each of the first internal electrode layers and the second internal electrode layers is about 2% or less of an entire dimension of each of the first internal electrode layers and the second internal electrode layers in the extending direction of each of the first internal electrode layers and the second internal electrode layers.

16. The multilayer ceramic capacitor according to claim 10, wherein the rare earth oxide in each of the first internal electrode layers and the second internal electrode layers is not included in a portion of each of the first internal electrode layers and the second internal electrode layers along a direction orthogonal or substantially orthogonal to the width direction of the multilayer body, of an outline of each electrode layer of the first internal electrode layers and the second internal electrode layers, when viewed in the height direction of the multilayer body of the first internal electrode layers and the second internal electrode layers.

17. The multilayer ceramic capacitor according to claim 16, wherein a ratio of a region not including the rare earth oxide in each of the first internal electrode layers and the second internal electrode layers and provided along a direction orthogonal to an extending direction of each of the first internal electrode layers and the second internal electrode layers is about 2% or less of an entire dimension of each of the first internal electrode layers and the second internal electrode layers in a direction orthogonal or substantially orthogonal to an extending direction of each of the first internal electrode layers and the second internal electrode layers.

18. The multilayer ceramic capacitor according to claim 10, wherein a content rate of the rare earth oxide in each of the first internal electrode layers and the second internal electrode layers is about 0.1 wt % or more and about 10 wt % or less, based on {(weight of rare earth oxide)/(weight of rare earth oxide+weight of main component metal of each of the first internal electrode layers and the second internal electrode layers)}×100.

19. A method for manufacturing a multilayer ceramic capacitor including a multilayer body including a plurality of internal electrode layers arranged to face each other and to be spaced apart from each other, and a dielectric layers between the plurality of internal electrode layers and including a ceramic material, and a plurality of outer electrodes on a surface of the multilayer body and selectively connected to the plurality of internal electrode layers, the method comprising:
applying a conductive paste for forming the plurality of internal electrode layers on a dielectric sheet corresponding to the dielectric layer; and
stacking, on the dielectric sheet to which the conductive paste is applied, another dielectric sheet to which the conductive paste is applied; wherein
the applying includes:
firstly applying a first conductive paste including a conductive material; and
secondarily applying a second conductive paste including a conductive material and a rare earth oxide, the secondarily applying being performed before, after, or both before and after the firstly applying; and
at least one of the stacking and the applying brings a surface to which the second conductive paste is applied, obtained by the secondarily applying, into contact with a surface of the dielectric sheet.
